(19) United States
(12) Patent Application Publication
(10) Pub. No.: US 2010/0165288 A1
(43) Pub. Date: Jul. 1, 2010

(54) Lens assemblies and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 12/318,350

(22) Filed: Dec. 29, 2008

(51) Int. Cl. G02C 7/08; G02B 3/10

(52) U.S. Cl. 351/172; 359/652

(57) ABSTRACT

The present invention generally relates to various lenses, lens assemblies, and devices using such lenses and/or lens assemblies, to various methods of fabricating and/or using such lenses, lens assemblies, and/or devices, and to various processes of making such lenses, lens assemblies, and/or devices. More particularly, the present invention relates to various lenses which may include multiple regions at least two of which may define different magnifications therethrough. Accordingly, various lens assemblies of the present invention may include multiple lenses at least one of which may define multiple magnifications and may translate, rotate or otherwise move laterally with respect to the other lens while overlapping or aligning with different portions of the other lens and while providing uniform magnifications across preset portions of overlapped or aligned regions of the lenses. In addition, the devices of the present invention may employ such lens assemblies and provide various magnifications by moving mobile lens of the lens assembly laterally relative to stationary lenses thereof. The present invention also relates to various methods of laterally moving such mobile lenses with respect to such stationary lenses, various methods of providing or using such lenses and/or lens assemblies in order to provide multiple magnifications by laterally moving such mobile lenses in order to overlap different portions of the stationary lens, and various methods of using such mobile lenses and lenses and lens assemblies to provide multiple magnifications to various devices. The present invention further relates to various processes for providing the foregoing lenses, lens assemblies, and devices.

### CROSS-REFERENCES TO RELATED APPLICATIONS

The present application claims an earlier invention date of a Disclosure Document entitled the same, deposited in the U.S. Patent and Trademark Office (the “Office”) on Dec. 26, 2006 under the Disclosure Document Deposit Program (the “DDDP”) of the Office, and bearing a Ser. No. 610,318 which is to be incorporated herein in their entirety by reference.

### FIELD OF THE INVENTION

The present invention generally relates to various lenses, lens assemblies, and devices using such lenses and/or lens assemblies, to various methods of fabricating and/or using such lenses, lens assemblies, and/or devices, and to various processes of making such lenses, lens assemblies, and/or devices. More particularly, the present invention relates to various lenses which may include multiple regions at least two of which may define different magnifications therethrough. Accordingly, various lens assemblies of the present invention may include multiple lenses at least one of which may define multiple magnifications and may translate, rotate or otherwise move laterally with respect to the other lens while overlapping or aligning with different portions of the other lens and while providing uniform magnifications across preset portions of overlapped or aligned regions of the lenses. In addition, the devices of the present invention may employ such lens assemblies and provide various magnifications by moving mobile lens of the lens assembly laterally relative to stationary lenses thereof. The present invention also relates to various methods of laterally moving such mobile lenses with respect to such stationary lenses, various methods of providing or using such lenses and/or lens assemblies in order to provide multiple magnifications by laterally moving such mobile lenses in order to overlap different portions of the stationary lens, and various methods of using such mobile lenses and lenses and lens assemblies to provide multiple magnifications to various devices. The present invention further relates to various processes for providing the foregoing lenses, lens assemblies, and devices.

### BACKGROUND OF THE INVENTION

Various lenses have been in use so as to refract light rays impinged thereupon. For example, concave or converging lenses refract and converge such light rays toward their focal points defined on an opposite side of an object and generate an real image of the object, while convex or diverging lenses refract and converge such light rays toward their focal points defined on the same side of the object and generate a virtual image of the object. Such lenses are generally used in glasses or, more particularly, prescription glasses, in order to correct myopia, hyperopia, and/or astigmatism of an user. Such lenses are also generally employed into various conventional image capturing and/or magnifying devices such as, e.g., cameras, camcorders, telescopes, microscopes, and other image capturing or magnifying devices.

Regardless of their converging or diverging characteristics, such conventional lenses suffer from their inflexibility in that each of such lenses is generally provided with a single focal length and a single magnification, each of which may be typically decided by radii of curvature of an outer surface and an inner surface of such a lens. Therefore, many people who have been suffering from myopia and who begin to suffer from hyperopia due to aging should generally carry two pairs of glasses one of which is for distant objects, while the other of which is for close objects. Although various bifocal lenses may be used for those people, such bifocal lenses also suffer from their own drawbacks. For example, such a bifocal lens includes two similar or different regions with different focal lengths and magnifications. Accordingly, an user may have only a limited area for each region or, conversely, the lens may have to be relatively large in order to maintain each region beyond a preset area. In addition, such a bifocal lens distributes such regions of different magnifications to its specific locations, which may cause the user to develop unnecessary and undesirable habits. When the regions are arranged vertically (as an upper region and a lower region) as is commonly seen in conventional bifocal lenses, e.g., the user may frown his face to use the upper region and may have to look downcast to use the lower region.

When conventional lenses are used in multiple as a lens assembly, however, magnifications of such assemblies may be varied, e.g., by moving one of multiple lenses axially with respect to others as is commonly seen in conventional zoom lenses. It is appreciated, however, that moving a lens of a lens assembly along an axial direction is not a practical option for most glasses.

Accordingly, there is a need for a novel lens assembly capable of varying its magnification by moving one of its lenses not along an axial direction but along a lateral direction. There also is a need for a novel lens which is capable of providing multiple magnifications when used with another lens of such a kind.

### SUMMARY OF THE INVENTION

The present invention generally relates to various lenses, lens assemblies, and devices using such lenses and/or lens assemblies, to various methods of fabricating and/or using such lenses, lens assemblies, and/or devices, and to various processes of making such lenses, lens assemblies, and/or devices. More particularly, the present invention relates to various lenses which may include multiple regions at least two of which may define different magnifications therethrough. Accordingly, various lens assemblies of the present invention may include multiple lenses at least one of which may define multiple magnifications and may translate, rotate or otherwise move laterally with respect to the other lens while overlapping or aligning with different portions of the other lens and while providing uniform magnifications across preset portions of overlapped or aligned regions of the lenses. In addition, the devices of the present invention may employ such lens assemblies and provide various magnifications by moving mobile lens of the lens assembly laterally relative to stationary lenses thereof. The present invention also relates to various methods of laterally moving such mobile lenses with respect to such stationary lenses, various methods of providing or using such lenses and/or lens assemblies in order to provide multiple magnifications by laterally moving such mobile lenses in order to overlap different portions of the stationary lens, and various methods of using such mobile lenses and lenses and lens assemblies to provide multiple magnifications to various devices. The present invention further relates to various processes for providing the foregoing lenses, lens assemblies, and devices.

In one aspect of the present invention, various multifocal lenses may be provided to generate multiple focal lengths.

In one exemplary embodiment of such an aspect of the present invention, a multifocal lens may include a curvilinear planar body which is arranged to define a first surface and an opposing second surface thereon and to have a first long axis, a second long axis, and a short axis. The first long axis is arranged to be the longest, the second long axis is arranged to be the second longest, whereas the short axis is arranged to be the shortest. These axes are generally arranged to be mutually normal or perpendicular to each other. Such a body may be provided in various configurations. In one example, the body may have at least three regions each of which may be arranged to be disposed laterally and successively between the surfaces and to be bounded by the surfaces. At least two adjacent ones of the regions are arranged to define different magnifications and to extend over at least substantially identical lengths (or widths) along the first and/or second long axes. In another example, such a body may have at least three regions each of which is arranged to be disposed successively between the surfaces, to be bounded by the surfaces, and to be disposed radially (or angularly) around an interior point of at least one of such surfaces. At least two adjacent ones of the regions may be arranged to have different magnifications and to extend radially (or angularly) over at least substantially identical angles with respect to the interior point. In another example, the body may also include at least three regions each arranged to be disposed successively between such surfaces, to be bounded by such surfaces, and to be disposed radially (or angularly) about an edge of the front and/or rear surfaces. At least two adjacent ones of such regions may be arranged to have different magnifications and to extend radially (or angularly) about at least substantially identical angles with respect to the edge. In yet another example, the body may also include at least three regions each arranged to be disposed successively between the surfaces, to be bounded by the surfaces, and to define a magnification. At least two adjacent ones of such regions may be arranged to define different magnifications and to have at least substantially identical (or similar) characteristic dimensions which are defined relative to the first and/or second long axes.

In another exemplary embodiment of such an aspect of the present invention, a multifocal lens may include a front surface, an opposing rear surface, and multiple regions. In one example, the lens may include at least three regions each arranged to be disposed laterally and successively between the surfaces and to be bounded by the surfaces. At least two adjacent ones of such regions may be arranged to have magnifications which increase successively along a preset curvilinear direction. In another example, the lens may have at least three regions each of which is arranged to be disposed successively between the surfaces, to be bounded by the surfaces, and to be disposed radially (or angularly) around an interior point of at least one of the surfaces. At least two adjacent ones of such regions may be arranged to define magnifications increasing successively along a preset curvilinear direction in a single revolution about the interior point. In another example, such a lens may include at least three regions each of which is arranged to be disposed successively between the surfaces, to be bounded by the surfaces, and to be also disposed radially (or angularly) about an edge of the front and/or rear surfaces. At least two adjacent ones of the regions are arranged to have magnifications increasing successively along a preset curvilinear direction. In another example, the lens may have at least three regions each arranged to be disposed successively between the surfaces, to be bounded by the surfaces, and to have a magnification. At least two adjacent ones of the regions are arranged to have magnifications which increase successively along a preset curvilinear direction.

In another exemplary embodiment of such an aspect of the present invention, a multifocal lens may include a body defining a first surface and an opposing second surface thereon, where the body may be provided according to various configurations. In one example, the body may include at least three regions each arranged to be disposed laterally and successively between such surfaces, to be bounded by the surfaces, to have a first radius of curvature along the first surface, to have a second radius of curvature along the second surface, and to define a magnification which may be determined by both radii of curvature. In addition, both of such surfaces may be contoured so that magnifications of at least two adjacent ones of the regions may be arranged to increase successively along a preset curvilinear direction. In another example, the body may include at least three regions each arranged to be disposed successively between such surfaces, to be bounded by such surfaces, to be disposed or oriented radially (or angularly) about an interior point of the body, to have a first radius of curvature along the first surface, to define a second radius of curvature along the second surface, and to have a magnification determined by both of the radii of curvature. More particularly, both of such surfaces may be contoured such that magnifications of at least two adjacent ones of the regions are arranged to increase successively in a single revolution about the interior point along a preset radial (or angular) direction. In another example, the body may have at least three regions each arranged to be disposed successively between the surfaces, to be bounded by such surfaces, and to be disposed radially (or angularly) around an edge of the body, to define a first radius of curvature along the first surface, to have a second radius of curvature along the second surface, and to have a magnification determined by both radii of curvature. In particular, both of such surfaces are contoured such that magnifications of at least two adjacent ones of the regions may be arranged to increase successively along a preset curvilinear direction. In another example, the body may include at least three regions each arranged to be disposed successively between such surfaces, to be bounded by such surfaces, to define a first radius of curvature along the first surface, to define a second radius of curvature along the second surface, and to define a magnification determined by both radii of curvature. In particular, both of the surfaces may be contoured such that magnifications of at least two adjacent ones of the regions are arranged to increase successively along a preset curvilinear direction.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. The magnifications of such regions may increase by a preset ratio. Alternatively, at least two of such regions may be arranged to define different lengths, widths, heights, angles, and so on. In addition, the above adjacent regions may be arranged to different radii of curvature, index of refraction, and so on. The characteristic dimension may include, e.g., a width, a length, an angle, and so on.

In another aspect of the present invention, various curvilinear lenses may be provided.

In one exemplary embodiment of such an aspect of this invention, a curvilinear lens includes a body defining thereon a first surface and an opposing second surface, at least one of which may be contoured to define a radius of curvature which varies continuously along a preset direction, thereby providing magnifications which also change along the preset direction.

In another exemplary embodiment of such an aspect of the present invention, a curvilinear lens may include a body defining thereon a first surface and an opposing second surface, where at least one of such surfaces may be contoured to be non-circular in at least a substantial portion thereof so as to define magnifications arranged to change along a preset direction.

In another exemplary embodiment of such an aspect of the present invention, a curvilinear lens may include a body defining thereon a first surface and an opposing second surface, where at least one of such surfaces may be contoured to be parabolic in at least a substantial portion thereof so as to provide magnifications changing along a preset direction.

In another exemplary embodiment of such an aspect of the present invention, a curvilinear lens may include a body defining thereon a first surface and an opposing second surface, where at least one of such surfaces may be contoured to be hyperbolic in at least a substantial portion thereof so as to provide magnifications changing along a preset direction.

In another exemplary embodiment of such an aspect of the present invention, a curvilinear lens may include a body defining thereon a first surface and an opposing second surface, where at least one of such surfaces may be contoured to be sinusoidal in at least a substantial portion thereof so as to provide magnifications changing along a preset direction.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof. The magnifications of such lenses may increase or decrease by a preset ratio along the direction per an unit dimension.

In another aspect of the present invention, various multifocal lens assembly may be provided.

In one exemplary embodiment of such an aspect of the present invention, a lens assembly may include a first lens, a second lens which may be movably disposed with respect to the first lens, and at least one coupling member arranged to allow lateral movement of such a second lens relative to the first lens between at least two preset positions. The second lens is arranged to move and overlap a different part of the first lens in each of the positions and to define a different magnification across at least a half (or a substantial portion) of the overlapped part in at least two of the positions.

In another exemplary embodiment of such an aspect of the present invention, a lens assembly may include a first lens, a second lens, and at least one coupling member. The first lens may define at least two regions arranged to have different magnifications, while the second lens may define at least two regions arranged to have different magnifications. The coupling member may then be arranged to allow lateral movement of the second lens with respect to the first lens between at least two preset positions. In addition, at least one of the regions of the second lens is arranged to move and overlap a different region of the first lens in each of the positions and to have a different magnification across at least a half (or a substantial portion) of the different region of the first lens in at least two of the above positions.

In another exemplary embodiment of such an aspect of the present invention, a lens assembly may similarly include a first lens, a second lens, and at least one coupling member. The first lens may be arranged to define a first front surface and a first rear surface and to include first multiple regions each of which may be arranged to be bound by both of the first surfaces, while the second lens may be arranged to define a second front surface and a second rear surface and to have second multiple regions each of which may be arranged to be bound by both of such second surfaces. The coupling member may then be arranged to allow lateral movement of the second lens with respect to the first lens between at least two preset positions. In addition, the first lens may be oriented so that at least two of the regions thereof may be arranged to define magnifications which increase successively in a preset curvilinear direction, and that the second lens may be oriented such that at least two of such regions thereof may be arranged to define magnifications which decrease successively in the preset curvilinear direction. Accordingly, these first and second lenses may be arranged to define different magnifications in at least substantial portions of overlapping parts of the lenses in at least two of such preset positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to define different lengths, widths, heights, angles, and the like. The magnifications of such regions may increase or decrease by a preset ratio.

The above second lens may be arranged to translate vertically or horizontally, to rotate about an interior point or an edge, and so on. At least one of the regions of the first lens may be arranged to align with one of adjacent regions of the second lens in one of the positions and to align with the other of the adjacent regions of the second lens in the other of the positions. One surface of the first lens and a matching surface of the second lens may also be arranged so that the second lens is movably disposed behind the first lens in a close proximity.

In another aspect of the present invention, various multi-lens assemblies may be provided.

In one exemplary embodiment of such an aspect of the present invention, a lens assembly may include a first lens, a second lens, and at least one coupling member. Such a first lens may include at least two adjacent regions defining different magnifications, while a second lens may include at least one region. The coupling member may be arranged to allow lateral movement of the second lens with respect to the first lens between at least two preset positions such that one region of the second lens aligns with one of the adjacent regions of the first lens in one of the positions, and then with the other of the adjacent regions of the first lens in the other of the positions.

In another exemplary embodiment of such an aspect of the present invention, a lens assembly may include a first lens, a second lens, and at least one coupling member. The first lens may have at least three adjacent regions defining different magnifications, while the second lens may have at least one region. The coupling member may be arranged to allow lateral movement of the second lens with respect to the first lens between at least two preset positions such that one region of the second lens may align with one region disposed on one end of the adjacent regions of the first lens in one of such positions, and then with another region disposed on an opposing end of such adjacent regions of the first lens in the other of the positions.

In another exemplary embodiment of such an aspect of the present invention, a lens assembly may include a first lens, a second lens, and at least one coupling member. The first lens may have at least two adjacent regions defining different magnifications, the second lens may include at least one active region and at least one inactive region, while such a coupling member may be arranged to allow lateral movement of such a second lens relative to the first lens between at least two preset positions along a preset direction. Moreover, the inactive region of the second lens may be disposed behind the active region of the second lens along the preset direction, where the region of the second lens may be arranged to align with one of the adjacent regions of the first lens in one of the positions, and then to align with the other of the adjacent regions of the first lens in the other of the positions. In addition, the inactive region of the second lens may be arranged to be disposed outside of the first lens in such one of the positions, and to align with such one of the adjacent regions of the first lens in the other of the positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to have different lengths, widths, heights, angles, and so on. In addition, the foregoing adjacent regions may be arranged to have different radii of curvature, indices of refraction, and the like, such that their magnifications may increase or decrease by a preset ratio in each of the foregoing lenses. Moreover, the characteristic dimension may be, e.g., a width, a length, an angle, and so on. The inactive region may be a blank, a colored region with or without a magnification, a region with a preset magnification which is not an unity, and the like. One surface of the first lens and a matching surface of the second lens may also be arranged so that the second lens is movably disposed behind the first lens in a close proximity.

In another aspect of the present invention, various multi-lens assemblies may be provided.

In one exemplary embodiment of such an aspect of the present invention, a lens assembly may include a first lens, a second lens, and at least one coupling member. The first lens may have at least two regions arranged to have at least one common characteristic dimension (and to optionally define different magnifications). Similarly, the second lens may have at least two regions arranged to have the same (or at least substantially similar) characteristic dimension (and to optionally define different magnifications). The coupling member may be arranged to allow lateral movement of the second lens with respect to the first lens between at least two preset positions. At least one of the regions of the second lens may be arranged to overlap one region of the first lens in one of the positions and then to move by about the characteristic dimension and overlap a different region of the first lens in the other of the positions so as to define different magnifications across at least a half (or a substantial portion) of the different overlapped regions of the lenses.

In another exemplary embodiment of such an aspect of the present invention, a lens assembly may have a first planar lens, a second planar lens, and at least one coupling member. The first planar lens may define a first top and a first bottom and may include at least two regions which are arranged to extend successively and laterally (or side by side) between the first top and bottom, to be adjacent to each other, to define at least substantially similar lengths and/or widths, and accordingly to define different magnifications. The second planar lens may define a second top and a second bottom and may include at least two regions which are arranged to extend successively and laterally (or side by side) between the second top and bottom, to be adjacent to each other, to have the foregoing lengths and/or widths, and to define different magnifications. The coupling member may be arranged to allow lateral movement of the second lens relative to the first lens between at least two preset positions. In addition, at least one of the regions of the second lens may be arranged to overlap one region of such a first lens in one of such positions, and then to translate laterally by about the width and to overlap a different region of the first lens in the other of the positions in order to define different magnifications across at least a half (or a substantial portion) of the different overlapped regions of the lenses.

In another exemplary embodiment of such an aspect of the present invention, a lens assembly may also include a first planar lens, a second planar lens, and at least one coupling member. The first planar lens may define a first top and a first bottom and may include at least two regions which may be arranged to extend successively and vertically (or one over the other) from the first top to the first bottom, to be adjacent to each other, to extend over at least substantially similar heights, and to define different magnifications. The second planar lens may define a second top and a second bottom and may form at least two regions which are arranged to extend successively and vertically (or one over the other) from the second top to the second bottom, to be adjacent to each other, to extend along the heights, and to define different magnifications. The coupling member may be arranged to allow lateral and vertical movement of the second lens with respect to the first lens between at least two preset positions. At least one of such regions of the second lens may be arranged to overlap one region of the first lens in one of such positions, and to translate vertically by about the height and to overlap a different region of the first lens in another of such positions, thereby defining different magnifications across at least a half (or a substantial portion) of the different overlapped regions of the lenses.

In another exemplary embodiment of such an aspect of the present invention, a lens assembly may have a first lens, a second lens, and at least one coupling member. Such a first planar lens may form at least one edge and an interior surrounded by the edge and include at least two regions which may be arranged to extend successively and radially (or angularly) around a point in the interior, to be adjacent to each other, to extend over at least substantially similar angles, and then to define different magnifications. The second planar lens may define at least one edge and also an interior surrounded by the edge, and include at least two regions which are arranged to extend successively and radially (or angularly) around a point in the interior, to be adjacent to each other, to extend over the foregoing angles, and to define different magnifications. The coupling member may be arranged to allow lateral and radial (or angular) movement of such a second lens with respect to the first lens between at least two preset positions. In addition, at least one of such regions of the second lens may be arranged to overlap one region of the first lens in one of the positions, and then to rotate radially (or angularly) by about the angle and to overlap a different region of the first lens in the other of the positions so as to define different magnifications across at least a half (or a substantial portion) of the above different overlapped regions of the lenses.

In another exemplary embodiment of such an aspect of the present invention, a lens assembly may have a first lens, a second lens, and at least one coupling member. Such a first planar lens may form at least one edge and an interior surrounded by the edge and include at least two regions which may be arranged to extend successively and radially (or angularly) around a point on the edge, to be adjacent to each other, to extend over at least substantially similar angles, and then to define different magnifications. The second planar lens may define at least one edge and also an interior surrounded by the edge and have at least two regions which are arranged to extend successively and radially (or angularly) about a point on the edge, to be adjacent to each other, to extend over at least substantially similar angles, and to define different magnifications. The coupling member may be arranged to allow lateral and radial (or angular) movement of the second lens with respect to the first lens between at least two preset positions. In addition, at least one of the regions of the second lens may be arranged to overlap one region of the first lens in one of such positions, and then to rotate radially (or angularly) by about the angle and to overlap a different region of the first lens in the other of the positions so as to define different magnifications across at least a half (or a substantial portion) of the above different overlapped regions of the lenses.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and so on. The characteristic dimension may include, e.g., a width, a length, an angle, and so on.

At least one of the regions of the first lens may also be arranged to align with one of adjacent regions of the second lens in one of the positions and to align with the other of the adjacent regions of the second lens in the other of the positions. One surface of the first lens and a matching surface of the second lens may be arranged such that the second lens is movably disposed behind the first lens in a close proximity.

In another aspect of the present invention, various multi-magnification lens assemblies may be provided as well.

In one exemplary embodiment of such an aspect of the present invention, a lens assembly may include a first stationary lens, a second movable lens, and at least one coupling member. The coupling member may similarly be arranged to allow lateral movement of such a second lens relative to the first lens between at least two preset positions. Such a second lens may be arranged to overlap different areas of the first lens in each of such positions and to define different magnifications across at least halves (or substantial portions) of the overlapped areas in at least two of the positions.

In another exemplary embodiment of such an aspect of the present invention, a lens assembly may include a first stationary lens, a second movable lens, and at least one coupling member. Such a first lens may include multiple regions having different magnifications, while the second movable lens may be arranged to be at most as large as the first lens and to have another multiple regions defining different magnifications. The coupling member may similarly be arranged to allow lateral movement of the second lens relative to the first lens between at least two preset positions. The second lens may be arranged to overlap different fractions of the first lens in each of the positions and, accordingly, to define different magnifications in at least halves (or substantial portions) of the overlapped parts in at least two of the positions.

In another exemplary embodiment of such an aspect of the present invention, a lens assembly may have a first stationary lens, a second movable lens, and at least one coupling member. The first lens may have multiple regions with different magnifications, while the second lens may be arranged to be larger than the first lens and to have another multiple regions having different magnifications. At least one coupling member may be arranged to allow lateral movement of the second lens relative to the first lens between at least two preset positions. In addition, the second lens may be arranged to overlap about a substantially entire area of the first lens in each of the positions and to align at least one preset region of the second lens with different region of the first lens, thereby defining different magnifications across at least halves (or substantial portions) of the entire area in at least two of the positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof. Such a second lens may be arranged to translate vertically or horizontally, to rotate about an interior point or an edge, and so on.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and the like. Such regions of the lenses may be arranged to define different radii of curvature, different indices of refraction, and so on. At least one of such regions of the first lens may be arranged to align with one of adjacent regions of the second lens in one of such positions, and then to align with the other of the adjacent regions of the second lens in the other of the positions. One surface of the first lens and a matching surface of the second lens may be arranged such that the second lens is movably disposed behind the first lens in a close proximity.

In another aspect of the present invention, various curvilinear lens may be provided.

In one exemplary embodiment of such an aspect of the present invention, a lens may include a first stationary lens, a second mobile lens, and at least one coupling member. The coupling member is arranged to allow lateral movement of the second lens relative to the first lens between at least two preset positions. At least one of the lenses may be arranged to define on at least one of its surfaces radii of curvature changing continuously in a preset direction. The second lens may also be arranged to overlap different portions of the first lens in the positions, thereby having different magnifications in at least halves (or substantial portions) of the overlapped areas in at least two of the positions.

In another exemplary embodiment of such an aspect of the present invention, such a lens may similarly include a first stationary lens, a second mobile lens, and at least one coupling member. Such a coupling member may be arranged to allow lateral movement of the second lens with respect to the first lens between at least two preset positions. Each of the lenses may be arranged to define along at least one of its surfaces radii of curvature changing continuously in a preset direction. The second lens may be arranged to overlap different portions of the first lens in such positions, thereby defining different magnifications in at least halves (or substantial portions) of the overlapped areas in at least two of the positions.

In another exemplary embodiment of such an aspect of the present invention, such a lens may similarly include a first stationary lens, a second mobile lens, and at least one coupling member. Such a coupling member may be arranged to allow lateral movement of the second lens with respect to the first lens between at least two preset positions. At least one of the lenses may be arranged to have at least one non-circular surface, while the second lens may be arranged to overlap different portions of such a first lens in such positions, thereby defining different magnifications in at least halves (or in at least substantial portions) of the overlapped areas in at least two of the positions.

In another exemplary embodiment of such an aspect of the present invention, such a lens may similarly include a first stationary lens, a second mobile lens, and at least one coupling member. Such a coupling member may be arranged to allow lateral movement of the second lens with respect to the first lens between at least two preset positions. At least one of the lenses may be arranged to define at least one parabolic surface, while the second lens may be arranged to overlap different portions of the first lens in the positions, thereby defining different magnifications in at least halves (or substantial portions) of the overlapped areas in at least two of the positions.

In another exemplary embodiment of such an aspect of the present invention, such a lens may similarly include a first stationary lens, a second mobile lens, and at least one coupling member. Such a coupling member may be arranged to allow lateral movement of the second lens with respect to the first lens between at least two preset positions. At least one of the lenses may be arranged to define at least one hyperbolic surface, while the second lens may be arranged to overlap different portions of the first lens in such positions, thereby defining different magnifications in at least halves (or in at least substantial portions) of the overlapped areas in at least two of the positions.

In another exemplary embodiment of such an aspect of the present invention, such a lens may similarly include a first stationary lens, a second mobile lens, and at least one coupling member. Such a coupling member may be arranged to allow lateral movement of the second lens with respect to the first lens between at least two preset positions. At least one of the lenses may be arranged to define at least one sinusoidal surface, and the second lens may be arranged to overlap different portions of the first lens in the positions, thereby defining different magnifications in at least halves (or substantial portions) of the overlapped areas in at least two of the positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof. In addition, the second lens may also be arranged to translate vertically or horizontally, to rotate about an interior point or an edge, and so on. In addition, the second lens may also be arranged to be disposed incrementally in more than two positions or, in the alternative, to be disposed at least substantially continuously in more than two positions.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and so on. At least one of such regions of the first lens may also be arranged to align with one of adjacent regions of the second lens in one of such positions and to align with the other of the adjacent regions of the second lens in the other of the positions. One surface of the first lens and a matching surface of the second lens may be arranged such that the second lens is movably disposed behind the first lens in a close proximity.

In another aspect of the present invention, various glasses may also be provided for refracting light rays transmitting therethrough and correcting myopia, hyperopia, and/or astigmatism of an user.

In one exemplary embodiment of such an aspect of the present invention, an exemplary pair of glasses may include a frame, at least one lens, and at least one coupling member. Such a frame may include at least one leg and at least one nose support. The lens assembly may be arranged to couple with a portion of the frame, to be disposed in front of one eye of the user, and to further include a first lens and a second lens. The coupling member may be arranged to laterally move the second lens with respect to the first lens, while maintaining overlapping of at least a portion of such a second lens over at least a portion of the first lens between at least two positions. In addition, such a second lens may be arranged to overlap different portions of such a first lens in each of the positions, thereby defining different magnifications in each of the positions.

In another exemplary embodiment of such an aspect of the present invention, a pair of glasses may have a frame, a left lens assembly, a right lens assembly, and at least one coupling member. The frame may include at least one leg, at least one nose support, and the like. The left lens assembly may be arranged to couple with a left portion of the frame, to be disposed in front of a left eye of the user, and to include a first left lens and a second left lens, while the right lens assembly may be arranged to couple with a right portion of the frame, to be disposed in front of a right eye of the user, and to have a first right lens and a second right lens. The coupling member may be arranged to laterally move the second left lens and second right lens relative to such a first left lens and first right lens, respectively, between at least two positions, while maintaining overlapping of at least a portion of the second left lens over at least a portion of the first left lens and overlapping of at least a portion of the second right lens over at least a portion of the first right lens. Each of the second left lens and right lens may also be arranged to overlap different portions of the first left lens and right lens, respectively, and to define different magnifications in the positions.

In another exemplary embodiment of such an aspect of the present invention, a pair of glasses may have a frame, a left lens assembly, a right lens assembly, and at least one coupling member. The frame may include at least one leg, at least one nose support, and the like. The left lens assembly may be arranged to couple with a left portion of the frame and to be disposed in front of a left eye of such an user, while the right lens assembly may be arranged to couple with a right portion of the frame and to be disposed in front of a right eye of such an user. At least one of such lens assemblies may also be arranged to include a first lens having first multiple first regions and a second lens having second multiple second regions. The coupling member may then be arranged to laterally move such a second lens between at least two positions with respect to the first lens, while maintaining overlapping of at least a portion of the second lens over at least a portion of the first lens. The second regions of such a second lens may be arranged to align with at least one of the first regions of the first lens in one of the two positions and to align with another of the first regions of the first lens adjacent to such one of the first regions in another of the two positions. Such at least one of the lens assemblies may also be arranged to define different magnifications in the different positions.

In another exemplary embodiment of such an aspect of the present invention, a pair of glasses may have a frame, a left lens assembly, a right lens assembly, and at least one coupling member. The frame may include at least one leg, at least one nose support, and so on. The left lens assembly may be arranged to couple with a left portion of the frame, to be disposed in front of a left eye of the user, and to include a first left lens including multiple first left regions and a second left lens having multiple second left regions. The right lens assembly may be arranged to be coupled to a right portion of such a frame, to be disposed in front of a right eye of the user, and to have a first right lens having multiple first right regions and a second right lens having multiple second right regions. The coupling member may be arranged to laterally move the second left lens between at least two left positions and to move the second right lens between at least two right positions, while maintaining at least a portion of such a second left lens over at least a portion of the first left lens and while maintaining at least a portion of such a second right lens over at least a portion of the first right lens. At least one of the second left regions of the second left lens may be arranged to align with at least one of the first left regions of the first left lens in one of the left positions and to align with another of the first left regions of the first left lens adjacent to such at least one of the first left regions in another of the left positions. At least one of the second right regions of the second right lens may be arranged to align with at least one of the first right regions of the first right lens in one of the right positions and to align with another of the first right regions of the first right lens adjoining such at least one of the first right regions in another of the right positions, thereby defining different magnifications by both of the left and right lens assemblies in the different positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and so on. The characteristic dimension may include, e.g., a width, a length, an angle, and so on.

The foregoing regions may be arranged to have different refraction indices. The frame may be arranged to encircle an entire portion of at least one of such lenses or, alternatively, to encircle only a portion of at least one of such lenses. The coupling member may be disposed in any location and also move at least one of the foregoing lenses not laterally but axially, both laterally and axially, and the like. Such glasses may include at least one release unit, recoil unit. In addition, all other features described hereinabove in conjunction with the above lenses and/or lens assemblies may apply to the lenses and lens assemblies of such glasses of this aspect of the present invention.

In another aspect of the present invention, various sunglasses may be provided for adjusting an amount and/or an intensity of light rays transmitting therethrough.

In one exemplary embodiment of such an aspect of the present invention, a pair of sunglasses may have a frame, at least one lens assembly, and at least one coupling member. Such a frame may include at least one leg and at least one nose support. The lens assembly may be arranged to couple with a portion of the frame, to be disposed in front of one eye of an user, and to have a first lens and a second lens. The coupling member may be arranged to laterally move the second lens with respect to the first lens between at least two positions, while maintaining overlapping of at least a portion of the second lens over at least a portion of the first lens. The second lens may be arranged to overlap different portions of the first lens in each of the positions, thereby providing different transmittivities to the light rays in each of the positions.

In another exemplary embodiment of this aspect of the present invention, a pair of sunglasses may have a frame, a left lens assembly, a right lens assembly, and at least one coupling member. The frame may include at least one leg, at least one nose support, and the like. The left lens assembly may be arranged to couple with a left portion of the frame, to be disposed in front of a left eye of an user, and to include a first left lens and a second left lens. The right lens assembly may be arranged to be coupled to a right portion of the frame, to be disposed in front of a right eye of the user, and to include a first right lens and a second right lens. The coupling member may be arranged to laterally move the second left lens and second right lens with respect to the first left lens and first right lens between at least two positions, respectively, while overlapping (or maintaining overlapping of) at least a portion of the second left lens over the first left lens and overlapping (or maintaining overlapping of) at least a portion of the second right lens over the first right lens. Each of the second left and right lenses may be arranged to overlap different portions of the first left and right lenses, respectively, and to provide different transmittivities to the light rays in the positions.

In another exemplary embodiment of this aspect of the present invention, a pair of sunglasses may have a frame, a left lens assembly, a right lens assembly, and at least one coupling member. The frame may include at least one leg, at least one nose support, and the like. The left lens assembly may be arranged to be coupled to a left portion of the frame and to be disposed in front of a left eye of an user, while the right lens assembly may be arranged to couple with a right portion of the frame and to be placed in front of a right eye of the user. At least one of such lens assemblies may be arranged to include a first lens having first multiple first regions and a second lens having second multiple second regions. The coupling member may be arranged to laterally move the second lens between at least two positions with respect to the first lens while maintaining at least a portion of the second lens over at least a portion of the first lens. Such second regions of the second lens may be arranged to align with at least one of the first regions of the first lens in one of the positions and to align with the other of the first regions of the first lens adjacent to such at least one of the first regions in the other of the positions. Such at least one of the lens assemblies may be arranged to define different transmittivities to the light rays in the different positions.

In another exemplary embodiment of this aspect of the present invention, a pair of sunglasses may have a frame, a left lens assembly, a right lens assembly, and at least one coupling member. The frame may include at least one leg, at least one nose support, and the like. The left lens assembly may be arranged to couple with a left portion of the frame, to be disposed in front of a left eye of an user, and to include a first left lens with multiple first left regions and a second left lens with multiple second left regions. The right lens assembly may be arranged to couple with a right portion of such a frame, to be disposed in front of a right eye of the user, and to have a first right lens having multiple first right regions and a second right lens having multiple second right regions. The coupling member may then be arranged to laterally move the second left lens relative to the first left lens between at least two left positions and to also move such a second right lens relative to the first right lens between at least two right positions while maintaining overlapping of at least a portion of the second left lens over at least a portion of the first left lens and overlapping of at least a portion of the second right lens over at least a portion of the first right lens. In addition, at least one of the second left regions of the second left lens may be arranged to align with at least one of the first left regions of the first left lens in one of the left positions and to align with another of the first left regions of the first left lens adjacent to such at least one of the first left regions in another of the left positions. Similarly, at least one of such second right regions of the second right lens may be arranged to align with at least one of the first right regions of the first right lens in one of the right positions, and to align with another of the first right regions of the first right lens adjacent to such at least one of the first right regions in the other of the right positions, thereby defining different transmittivities to the light rays by both of the left and right lens assemblies in their different positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and so on. The characteristic dimension may include, e.g., a width, a length, an angle, and so on.

Such regions may be arranged to have different refraction indices, transmittivities, colors, and so on. Such regions may be arranged to have different polarities defined along different directions as well. The frame may be arranged to encircle an entire portion of at least one of such lenses or, in the alternative, to encircle only a portion of at least one of such lenses. The coupling member may also be disposed in any location and move at least one of the lenses not laterally but axially, both laterally and axially, and the like. Such sunglasses may include at least one release unit, recoil unit. In addition, all other features described hereinabove in conjunction with the foregoing lenses and/or lens assemblies may apply to the lenses and/or lens assemblies of such sunglasses of such an aspect of the present invention.

In another aspect of the present invention, various image capturing devices may be provided for acquiring still images and/or dynamic images.

In one exemplary embodiment of this aspect of the present invention, such an image capturing device may include a body, at least one lens assembly, at least one coupling member, and at least one image generating member. The lens assembly may be arranged to be implemented into a portion of the body and to include a first lens and a second lens. The coupling member may be arranged to laterally move the second lens with respect to the first lens, while maintaining overlapping of at least a portion of the second lens over at least a portion of the first lens between at least two positions. In addition, the image generating member may also be arranged to operatively couple with such a lens assembly, to receive light rays emanating from an object and refracted by the lens assembly, and to generate at least one of the still and dynamic images therefrom. Such a second lens may be arranged to overlap a different portion of the first lens in each of the positions, thereby defining a different magnification in each of the positions.

In another exemplary embodiment of this aspect of the present invention, an image capturing device may include a body, at least one lens assembly, at least one coupling member, and at least one image generating member. The lens assembly may be arranged to be implemented into a portion of the body and to include a first lens and a second lens. The image generating member may be arranged to operatively couple with the lens assembly, to receive light rays which emanate from an object and are refracted by the lens assembly, and to generate the still and/or dynamic images therefrom. Such first and/or second lenses may be arranged to have first multiple first regions and second multiple second regions, respectively. The coupling member may be arranged to laterally move the second lens with respect to the first lens, while maintaining overlapping of at least a portion of the second lens over at least a portion of the first lens between at least two positions. The second regions of such a second lens may be arranged to align with at least one of the first regions of the first lens in one of the above positions, and to align with another of the first regions of the first lens adjacent to such at least one of the first regions in the other of the positions, thereby defining different magnifications in the positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and so on. The characteristic dimension may include, e.g., a width, a length, an angle, and so on.

Such regions may be arranged to have different refraction indices, transmittivities, colors, and so on. The lens assembly may be disposed in one end of the body. Such a device may be a camera, a camcorder, and other conventional image capturing articles. Such an image generating member may use photosensitive films, CCD's, conventional image generating articles, and the like. Such a coupling member may be disposed in any location and move at least one of such lenses not laterally but axially, both laterally and axially, and the like. Such a device may include at least one release unit, recoil unit. In addition, all other features described hereinabove in conjunction with the above lenses and/or lens assemblies may apply to the lenses and/or lens assemblies of such image capturing devices of such an aspect of the present invention.

In another aspect of the present invention, various image magnifying device may be provided for providing a magnified image of a distant object.

In one exemplary embodiment of such an aspect of the present invention, a device may include a body, at least one lens assembly, at least one third lens, and at least one coupling member. The lens assembly may be arranged to be incorporated into an end of the device away from an eye of an user and to include a first lens and a second lens, whereas the third lens may be arranged to be disposed in another end of the device which is more adjacent to the eye of the user. The coupling member may be arranged to laterally move the second lens with respect to the first lens of the lens assembly while maintaining overlapping of at least a portion of the second lens over at least a portion of the first lens between at least two positions. Such a second lens may be arranged to overlap a different portion of the first lens in each of the positions, thereby providing different magnifications to the lens assembly in such positions and allowing the device to provide the images magnified by different magnifications in such positions.

In another exemplary embodiment of this aspect of the present invention, a device may include a body, at least one third lens, at least one lens assembly, and at least one coupling member. Such a third lens may be arranged to be disposed in one end of the device which is away from an eye of an user, while the lens assembly may be arranged to be incorporated into an opposite end of the device more adjacent to the eye of the user and to have a first lens and a second lens. The coupling member may be arranged to laterally move the second lens relative to the first lens of the lens assembly while maintaining overlapping of at least a portion of the second lens over at least a portion of the first lens between at least two positions. Such a second lens may be arranged to overlap a different portion of the first lens in each of the positions, thereby providing different magnifications to the lens assembly in such positions and allowing the device to provide the images magnified by different magnifications in such positions.

Embodiments of this aspect of the invention may include one or more of the following features.

Any of the above lens may be a concave lens, a convex lens or a combination or hybrid lens which is a combination of the concave and convex lenses. The above lens may be arranged to have various shapes and/or sizes such as, e.g., triangles, rectangles, squares, diamonds, parallelograms, polygons, circles, ovals, and combinations thereof.

At least two of the above regions may be arranged to extend in an at least substantially similar length, width, height, angle, and so on. Alternatively, at least two of such regions may be arranged to define different lengths, widths, heights, angles, and so on. The magnifications of such regions may increase by a preset ratio. In addition, the above adjacent regions may be arranged to different radii of curvature, index of refraction, and so on. The characteristic dimension may include, e.g., a width, a length, an angle, and so on.

Such regions may be arranged to have different refraction indices. The coupling member may be disposed in any location and move at least one of such lenses not laterally but axially, both laterally and axially, and the like. Such a device may include at least one release unit, recoil unit. Examples of such devices may include, but not be limited to, binoculars, telescopes, microscopes, and the like. All other features described hereinabove in conjunction with the foregoing lenses and/or lens assemblies may apply to the lenses and/or lens assemblies of such image capturing devices of such an aspect of the present invention.

Embodiments of the foregoing aspects of the present invention may include one or more of the following features as well.

Any of the above lens assemblies may further be arranged to have more than two first lenses, more than two second lenses, more than two third lenses, and so on. The first lenses may preferably move in unison with respect to the second and/or third lenses, and the second lenses may preferably move in unison with respect to the first and/or third lenses.

At least one of the above regions may be arranged to include at least one cylindrical portion so as to correct astigmatism of an user. Similarly, at least one of the lenses may be arranged to have at least one extra lens which may be coupled to such at least one of the lenses so as to correct various aberrations of the lenses such as, e.g., spherical aberration, circles of confusion, off-axis aberration, chromatic aberration, and so on.

In another aspect of this invention, various methods may be provided for constructing lenses.

In one exemplary embodiment of such an aspect of this invention, such a method may include the steps of defining multiple regions successively and laterally along one long axis of such a lens and one of the following steps such as, e.g., arranging at least two adjacent regions to define at least one common characteristic dimension; arranging the same adjacent regions to have different focal lengths and, accordingly, to define magnifications which may be arranged to successively increase along the long axis; and arranging at least three adjacent regions to have different focal lengths and, therefore, to have magnifications arranged to successively increase along the long axis.

In another exemplary embodiment of this aspect of the present invention, a method may include the steps of defining multiple regions successively and angularly about a preset point of the lens and one of the following steps such as, e.g., arranging at least two adjacent regions to define at least one common characteristic dimension; arranging the same adjacent regions to have different focal lengths and, accordingly, to have magnifications which may be arranged to successively increase along the long axis; and arranging at least three adjacent regions to have different focal lengths and, therefore, to have magnifications arranged to successively increase along the long axis.

In another exemplary embodiment of this aspect of the present invention, another method may include the steps of defining a first surface and an opposing second surface on the lens and one of the following steps such as, e.g., conforming a curvature of at least a substantial portion of the first and/or second surfaces to a non-circular continuous curve; and conforming a curvature of at least a portion of the first and/or second surfaces to a continuous parabola, a continuous hyperbola, and/or a continuous sinusoid.

Embodiments of this aspect of the invention may include one or more of the following features.

Such a method may include at least one of the steps of arranging such a lens to be concave or convex and arranging such a lens in various shapes and/or sizes, where the above dimension may be a length, a width, a diameter, an angle, and so on. The method may also include one of the steps of extending at least two of the regions in an at least substantially similar length, width, height, angle, and the like; and extending at least two of the regions along different lengths, widths, heights, angles, and the like. The method may include the step of arranging one of the regions to be an inactive region which may be blank, colored, and so on. The method may include the step of disposing such a preset point in or near a center of the lens, on an edge of the lens, and so on. The method may also include the step of arranging the magnifications of multiple regions of the lens to increase by a preset ratio.

In another aspect of the present invention, various methods may also be provided for movably coupling multiple lenses.

In one exemplary embodiment of this aspect of the present invention, a method may include the steps of providing a first stationary lens and movably disposing (or aligning) a second mobile lens on a plane parallel with the first lens. Such a method may include one of the following steps such as, e.g., laterally moving the second lens from one to another of at least two positions which may be defined on the plane while maintaining overlapping of different areas (or different portions) of the first lens by the second lens; laterally translating the second lens vertically and/or horizontally over the plane while maintaining overlapping of different areas of the first lens by the second lens; and laterally rotating the second lens about a preset position on the plane about a preset angle while maintaining overlapping of different areas of the first lens by the second lens.

In another exemplary embodiment of this aspect of the present invention, a method may include the steps of providing a first stationary lens and movably disposing a second mobile lens with respect to the first lens. The method may include one of the steps of laterally and/or axially moving the second lens from one to the other of at least two positions while maintaining overlapping of different portions (or different areas) of the first lens by the second lens; laterally and/or axially translating the second lens horizontally and/or vertically while maintaining overlapping of different portions of the first lens by the second lens; and laterally and axially rotating such a second lens about a preset position about a preset angle while maintaining overlapping of different portions of the first lens by the second lens.

In another exemplary embodiment of this aspect of the present invention, a method may include the steps of providing a first lens, providing (or aligning) a second mobile lens over (or with) the first lens while disposing a surface of the second lens movably over a surface of the first lens, and one of the following steps such as, e.g., laterally moving the second lens with respect to the first lens while overlapping different portions of the first lens by the second lens and while maintaining such movably disposing; laterally translating the second lens with respect to the first lens while overlapping different areas of the first lens by such a second lens and while maintaining such movably disposing; laterally rotating the second lens with respect to the first lens while overlapping different portions of the first lens by the second lens and while maintaining such movably disposing; laterally and axially moving the second lens relative to the first lens while overlapping different portions of such a first lens by such a second lens and while maintaining such movably disposing; laterally and axially translating the second lens with respect to the first lens while overlapping different portions of the first lens by the second lens and while maintaining such movably disposing; and laterally and axially rotating the second lens with respect to the first lens while overlapping different portions of the first lens by the second lens and while maintaining such movably disposing.

In another exemplary embodiment of this aspect of the present invention, a method may include the steps of providing a first lens, movably disposing a second mobile lens typically in parallel with the first lens, moving the second lens to one position with respect to the first lens, thereby overlapping a first area of the first lens by the second lens to define at least substantially uniform first magnification across at least a substantial portion of the first area, and moving the second lens to another position with respect to the first lens, thereby overlapping a second area of the first lens by the second lens to generate a second uniform magnification in at least a substantial portion of the second area.

Embodiments of this aspect of the invention may include one or more of the following features.

Such a method may include at least one of the steps of arranging such a lens to be concave or convex and arranging such a lens in various shapes and/or sizes, where the above dimension may be a length, a width, a diameter, an angle, and the like. The method may also include one of the steps of arranging the second lens larger (or smaller) than the first lens and arranging the first and second lenses to have similar sizes. Such a method may include the step of providing the second lens a blank region, a colored region, and so on. The above step of moving may include translating and/or rotating (or pivoting), where such translating may be vertical and/or horizontal translating. The step of rotating (or pivoting) may include rotating (or pivoting) about a point in or near a center of the lens, on an edge of the lens, and so on. Such a method may include the step of arranging the magnifications of multiple regions of the lens to increase by a preset ratio.

In another aspect of the present invention, various methods may be provided for moving a lens of a lens assembly with respect to another lens of the assembly.

In one exemplary embodiment of this aspect of the present invention, a method may include the steps of disposing a first lens in relation to a body of the lens assembly, movably disposing a second lens in relation to the body, and then moving the second lens relative to the first lens while overlapping different portions of the first lens by the at least a portion of the second lens.

In another exemplary embodiment of this aspect of the present invention, a method may include the steps of disposing a first lens to a body of the lens assembly and providing a second mobile lens which is capable of moving laterally with respect to the first lens. The method may include one of the steps of laterally translating the second lens vertically and/or horizontally with respect to the first lens while overlapping different portions of the first lens thereby and/or laterally rotating (or pivoting) such a second lens with respect to the first lens by a preset angle while overlapping different portions of the first lens by the second lens.

In another exemplary embodiment of this aspect of the present invention, a method may include the steps of disposing a first lens to a body of the lens assembly and providing a second mobile lens capable of moving laterally and axially with respect to the first lens while overlapping at least a portion of the first lens by at least a portion of such a second lens. The method may also include one of the steps of laterally and axially translating the second lens horizontally and/or vertically while overlapping different portions of the first lens by the second lens and laterally and axially rotating (or pivoting) the second lens around a preset angle while overlapping different portions of the first lens by the second lens.

Embodiments of this aspect of the invention may include one or more of the following features.

Such a method may include at least one of the steps of arranging such a lens to be concave or convex and arranging such a lens in various shapes and/or sizes, where the above dimension may be a length, a width, a diameter, an angle, and the like. The method may also include one of the steps of arranging the second lens larger (or smaller) than the first lens and arranging the first and second lenses to have similar sizes. Such a method may include the step of providing the second lens a blank region, a colored region, and so on. The above step of moving may include translating and/or rotating (or pivoting), where such translating may be vertical and/or horizontal translating. The step of rotating (or pivoting) may include rotating (or pivoting) about a point in or near a center of the lens, on an edge of the lens, and so on. Such a method may include the step of arranging the magnifications of multiple regions of the lens to increase by a preset ratio.

In another aspect of the present invention, various methods may also be provided for aligning at least one region of a lens of a lens assembly with at least two regions of another lens of the same lens assembly.

In one exemplary embodiment of this aspect of the present invention, a method may include the steps of providing a first lens including multiple first regions at least two of which may be arranged to have different magnifications and to extend in at least one similar characteristic dimension, providing a second lens having at least one second region with a preset magnification, aligning the second region with one of the at least two of the first regions, and moving the second lens by such a characteristic dimension, thereby aligning the second region with the other of such at least two of the first regions.

In another exemplary embodiment of this aspect of the present invention, a method may include the steps of providing a first lens with multiple first regions at least three of which may be arranged to have different magnifications and to extend in at least one similar characteristic dimension, providing a second lens having multiple second regions at least two of which may be arranged to have different magnifications and to extend along such a dimension, aligning the second regions with two of such at least three of the first regions, and moving the second lens by the characteristic dimension to align the second regions with another two of such at least three of the first regions.

Embodiments of this aspect of the invention may include one or more of the following features.

Such a method may include at least one of the steps of arranging such a lens to be concave or convex and arranging such a lens in various shapes and/or sizes, where the above dimension may be a length, a width, a diameter, an angle, and the like. The method may also include one of the steps of arranging the second lens larger (or smaller) than the first lens and arranging the first and second lenses to have similar sizes. Such a method may include the step of providing the second lens a blank region, a colored region, and so on. The method may include the step of arranging at least two of the regions of at least one of the lenses to define magnifications which may successively increase by a preset ratio. In addition, the above dimension may include a length, a width, an angle, and so on.

The step of moving may include translating and/or rotating (or pivoting), where such translating may be vertical and/or horizontal translating. The step of rotating (or pivoting) may include rotating (or pivoting) about a point in or near a center of the lens, on an edge of the lens, and the like. The method may include the step of arranging at least one of the first regions to have different magnifications with at least two of the second regions when aligned therewith. The method may further include the step of arranging the magnifications of multiple regions of the lens to increase by a preset ratio.

In another aspect of the present invention, various methods may also be provided for changing or varying magnifications of a lens assembly.

In one exemplary embodiment of this aspect of the present invention, a method may include the steps of disposing a first lens to a body of the assembly, providing multiple first regions which may be arranged to define different magnifications, movably implementing a second lens to the body, providing multiple second regions having different magnifications, and then moving the second lens with respect to the first lens while overlapping at least one region of the second lens by at least two of the regions of the first lens, thereby varying magnifications in at least a portion of at least one overlapping region of the first and second lenses due to the moving.

In another exemplary embodiment of this aspect of the present invention, a method may include the steps of placing a first lens to a body of the lens assembly, providing multiple first regions defining magnifications successively increasing by a preset ratio along a preset direction, movably disposing a second lens to the body, providing multiple second regions having magnifications which successively decrease by the preset ratio along the preset direction, and then moving the second lens with respect to the first lens while overlapping at least one region of the second lens by at least two of the regions of the first lens, thereby varying magnifications in at least a portion of at least one overlapping region of the first and second lenses due to the moving.

Embodiments of this aspect of the invention may include one or more of the following features.

Such a method may include at least one of the steps of arranging such a lens to be concave or convex and arranging such a lens in various shapes and/or sizes, where the above dimension may be a length, a width, a diameter, an angle, and the like. The method may also include one of the steps of arranging the second lens larger (or smaller) than the first lens and arranging the first and second lenses to have similar sizes. Such a method may include the step of providing the second lens a blank region, a colored region, and so on. The step of above moving may include translating and/or rotating (or pivoting), where such translating may be vertical and/or horizontal translating. The step of rotating (or pivoting) may include rotating (or pivoting) about a point in or near a center of the lens, on an edge of the lens, and the like. The method may include the step of arranging at least one of the first regions to have different magnifications with at least two of the second regions when aligned therewith. The method may include the step of arranging the magnifications of multiple regions of the lens to increase by a preset ratio.

In another aspect of the present invention, various methods may also be provided to generate an uniform magnification over at least a substantial portion overlapped by at least two lenses of a lens assembly.

In one exemplary embodiment of this aspect of the present invention, a method may include the steps of providing a first lens having multiple regions with different magnifications, providing a second mobile lens including multiple regions with different magnifications, disposing the second lens in a first preset position in which the second lens may be arranged to define a first overlapped portion with the first lens, thereby defining at least substantial uniform first magnifications across the first overlapped portion, and moving the second lens to a second preset position where the second lens is arranged to define a second overlapped portion with the first lens, thereby defining at least substantially uniform second magnifications across the second overlapped portion.

In another exemplary embodiment of this aspect of the present invention, a method may include the steps of providing a first lens with multiple regions at least two of which may be arranged to have different magnifications, providing a second mobile lens having multiple second regions at least two of which may be arranged to define different magnifications, disposing such a second lens in one preset position where the above at least two regions of the second lens may be arranged to align with such at least two regions of the first lens and to form a uniform first magnification thereacross, and moving the second lens to another preset position where one of such at least two regions of the second lens may be arranged to align with another of such at least two regions of the first lens, thereby defining a second magnification thereacross.

In another exemplary embodiment of this aspect of the present invention, a method may include the steps of providing a first lens including multiple first regions at least three of which are arranged to have different magnifications, providing a second mobile lens including multiple second regions at least two of which may be arranged to define different magnifications, disposing the second lens in a first preset position in which such at least two regions of the second lens may be arranged to align with first two of such at least three regions of the first lens and to define at least substantially uniform first magnifications thereacross, and moving the second lens to a second preset position in which such at least two regions of the second lens may be arranged to align with second two of such at least three regions of the first lens and to define at least substantially uniform second magnification thereacross.

In another exemplary embodiment of this aspect of the present invention, a method may include the steps of providing a first lens with at least one first surface with a non-circular contour, providing a second mobile lens with at least one second surface having a non-circular contour, aligning the first and second surfaces of the lenses, disposing such a second lens in one position in which the lenses may be arranged to define a first overlapping portion and to have an at least substantially uniform first magnification across at least a substantial part of the first portion, and moving such a second lens to a different position in which the lenses may be arranged to define a second overlapping portion and to have an at least substantially uniform second magnification across at least a substantial part of such a second portion.

Embodiments of this aspect of the invention may include one or more of the following features.

Such a method may include at least one of the steps of arranging such a lens to be concave or convex and arranging such a lens in various shapes and/or sizes, where the above dimension may be a length, a width, a diameter, an angle, and the like. The method may also include one of the steps of arranging the second lens larger (or smaller) than the first lens and arranging the first and second lenses to have similar sizes. Such a method may include the step of providing the second lens a blank region, a colored region, and so on. The step of above moving may include translating and/or rotating (or pivoting), where such translating may be vertical and/or horizontal translating. The step of rotating (or pivoting) may include rotating (or pivoting) about a point in or near a center of the lens, on an edge of the lens, and the like. The method may include the step of arranging at least one of the first regions to have different magnifications with at least two of the second regions when aligned therewith. The method may include the step of arranging the magnifications of multiple regions of the lens to increase by a preset ratio. The method may include the step of arranging at least two of the regions of at least one of the lenses to define magnifications successively increasing by a preset ratio.

In another aspect of the present invention, various multifocal lenses may be fabricated through various processes.

In one exemplary embodiment of such an aspect of the present invention, such a process may include the step of successively and laterally disposing multiple regions along one long axis of such a lens and may include one of the following steps such as, e.g., arranging at least two of the regions to have at least one common characteristic dimension and to have different magnifications; arranging at least two of such regions to have different focal lengths and, therefore, to have magnifications which are arranged to successively increase along the long axis; and arranging at least three of the regions to have different focal lengths and, thus, to have magnifications which are arranged to successively increase along the long axis.

In another exemplary embodiment of such an aspect of the present invention, a process may include the step of successively and angularly disposing multiple regions about a point of the lens and may include one of the following steps such as, e.g., arranging at least two of such regions to have at least one common characteristic dimension and to have different magnifications; arranging at least two of such regions to have different focal lengths and, therefore, to have magnifications which are arranged to successively increase along the long axis; and arranging at least three of the regions to have different focal lengths and, therefore, to define magnifications which are arranged to increase successively along the long axis.

In another exemplary embodiment of such an aspect of the present invention, a process may include the step of providing the lens with a first surface and an opposing second surface and may include one of the following steps such as, e.g., conforming a curvature of at least a substantial part of the first and/or second surfaces to a non-circular continuous curve; and conforming a curvature of at least a substantial part of the first and/or second surfaces to a continuous parabola, a continuous hyperbola, a continuous sinusoid, and the like.

In another aspect of the present invention, various multifocal lens assemblies may be provided by various processes.

In one exemplary embodiment of such an aspect of the present invention, such a process may include the steps of providing a first stationary lens and disposing a second mobile lens along a plane parallel with the first lens. Such a method may also include one of the following steps such as, e.g., arranging the second lens to laterally move between at least two positions defined on the plane while maintaining overlapping of different portions of the first lens by the second lens; arranging the second lens to laterally translate along the plane vertically and/or horizontally while maintaining overlapping of different areas of the first lens by the second lens; and arranging the second lens to laterally rotate about a preset position defined along the plane about a preset angle while maintaining overlapping of different areas of the first lens by the second lens.

In another exemplary embodiment of such an aspect of the present invention, a process may include the steps of providing a first stationary lens and disposing a second mobile lens relative to the first lens. Such a method may include one of the following steps such as, e.g., arranging the second lens to laterally and/or axially move between at least two positions while maintaining overlapping of at least two different portions of the first lens by the second lens; arranging the second lens to laterally and axially translate over such a first lens horizontally and/or vertically while maintaining overlapping of different areas of the first lens by the second lens; and arranging the second lens to laterally and axially rotate (or pivot) about the first lens while maintaining overlapping of different areas of the first lens by the second lens.

In another exemplary embodiment of such an aspect of the present invention, a process may include the steps of providing a first lens and providing a second mobile lens over the first lens while movably disposing a surface of the second lens over a surface of the first lens. Such a method may also include one of the following steps such as, e.g., arranging the second lens to laterally move with respect to the first lens while overlapping different portions of the first lens and while maintaining the above movably disposing; arranging the second lens to laterally translate relative to the first lens while overlapping different portions of the first lens thereby and while maintaining the movably disposing; arranging the second lens to laterally rotate with respect to the first lens while overlapping different portions of the first lens by the second lens and while maintaining the movably disposing; arranging the second lens to laterally and axially move with respect to the first lens while overlapping different areas of the first lens by the second lens and while maintaining the movably disposing the surfaces; arranging the second lens to laterally and axially translate relative to the first lens while overlapping different portions of the first lens by the second lens and while maintaining the movably disposing the surfaces; and arranging the second lens to laterally and axially rotate the second lens relative to the first lens while overlapping different areas of the first lens by the second lens and while maintaining the movably disposing the surfaces.

In another exemplary embodiment of such an aspect of the present invention, a process may include the steps of providing a first lens, disposing a second mobile lens generally in parallel with the first lens, arranging the second lens to overlap a first area of the first lens and to form a first uniform magnification across at least a substantial portion of the first area in one position, and arranging such a second lens to overlap a second area of the first lens and to define a second uniform magnification across at least a substantial portion of the second area in another position.

In another aspect of the present invention, various multifocal lens assemblies may be provided by various processes.

In one exemplary embodiment of such an aspect of the present invention, such a process may include the steps of providing a first lens, providing a second lens, movably coupling the second lens to the first lens, thereby allowing lateral movement of such a second lens with respect to the first lens between at least two preset positions, and arranging the second lens to move and overlap a different part of the first lens in each of such positions and to define a different magnification across at least a half (or a substantial portion) of the overlapped part in at least two of the positions.

In another exemplary embodiment of such an aspect of the present invention, a process may include the steps of providing a first lens having at least two regions defining different magnifications, providing a second lens having at least two regions forming different magnifications, movably coupling the second lens to the first lens, thereby allowing lateral movement of the second lens with respect to the first lens between at least two preset positions, and arranging at least one of the regions of such a second lens to overlap different regions of the first lens in the above positions and to have different magnifications across at least a half (or a substantial portion) of the different regions of the first lens in at least two of the positions.

In another exemplary embodiment of such an aspect of the present invention, a process may include the steps of providing a first lens with a first front surface and a first rear surface, defining in the first lens multiple first regions each of which is arranged to be bound by both of the first surfaces, providing a second lens including a second front surface and a second rear surface, defining in such a second lens multiple second regions each of which is arranged to be bound by both of the second surfaces, movably coupling the second lens to the first lens, thereby allowing lateral movement of the second lens relative to the first lens between at least two preset positions, arranging at least two of the regions of the first lens to define magnifications increasing successively along a preset curvilinear direction, and arranging at least two of the regions of the second lens to define magnifications which decrease successively along the preset curvilinear direction, thereby defining different magnifications across at least substantial portions of overlapping portions of the lenses in at least two of the preset positions.

In another aspect of the present invention, various multi-lens assemblies may be fabricated by various processes.

In one exemplary embodiment of such an aspect of the present invention, such a process may include the steps of providing a first lens having at least two adjacent regions which define different magnifications, providing a second lens with at least one region, movably coupling member the second lens to the first lens, and arranging the second lens to laterally move relative to the first lens between at least two preset positions, thereby aligning the region of the second lens with one of such adjacent regions of the first lens in one of such positions, and with another of the adjacent regions of the first lens in the other of the positions.

In another exemplary embodiment of such an aspect of the present invention, a process may include the steps of providing a first lens having at least three adjacent regions which define different magnifications, providing a second lens with at least one region, movably coupling the second lens to the first lens, and arranging the second lens to laterally move relative to the first lens between at least two preset positions, thereby aligning the region of the second lens with one region disposed in one end of such adjacent regions of the first lens in one of the positions and with another region disposed in an opposing end of the adjacent regions of the first lens in the other of the positions.

In another exemplary embodiment of such an aspect of the present invention, a process may include the steps of providing a first lens having at least two adjacent regions which define different magnifications, providing a second lens with at least one active region and an inactive region, movably coupling the second lens to the first lens, disposing the inactive region of the second lens behind (or under) the active region of the second lens along the preset direction, arranging the second lens to laterally move with respect to the first lens between at least two preset positions in a preset direction, thereby aligning the region of the second lens with one of the adjacent regions of the first lens in one of the positions and then with another of the adjacent regions thereof in the other of the positions, and arranging the inactive region of the second lens to be disposed outside of the first lens in such one of the positions, and then to align with the one of the adjacent regions of the first lens in the other of the positions.

In another aspect of the present invention, various multi-lens assemblies may be fabricated by various processes.

In one exemplary embodiment of such an aspect of the present invention, such a process may include the steps of providing a first lens including at least two regions which extend over at least one common characteristic dimension (and defining different magnifications), providing a second lens with at least two regions which may also extend along the same characteristic dimension (and/or defining different magnifications), movably coupling the second lens to the first lens, arranging the second lens to laterally move relative to the first lens between at least two preset positions, thereby overlapping at least one of such regions of the second lens with one region of the first lens in one of such positions, and arranging such a second lens to move by about the same characteristic dimension and to overlap a different region of the first lens in another of the positions (so as to define different magnifications across at least a half (or a substantial portion) of the different overlapped regions of the lenses).

In another exemplary embodiment of such an aspect of the present invention, a process may include the steps of providing a first planar lens including a first top and a first bottom and defining at least two regions arranged to extend successively and laterally (or side by side) between the first top and bottom, to be adjacent to each other, to extend in at least substantially similar lengths (or widths), and to define different magnifications, providing a second planar lens with a second top and a second bottom and defining at least two regions arranged to extend successively and laterally (side by side) between the second top and bottom, to be adjacent to each other, to extend in the lengths (or widths), and to define different magnifications, movably coupling such a second lens to the first lens, thereby allowing lateral movement of such a second lens relative to the first lens between at least two preset positions, and arranging at least one of such regions of the second lens to overlap one region of such a first lens in one of the positions, and to translate laterally by about the width and overlap a different region of the first lens in another of the positions (in order to define different magnifications across at least a half (or a substantial portion) of the different overlapped regions of the lenses).

In another exemplary embodiment of such an aspect of the present invention, a process may include the steps of providing a first planar lens defining a first top and a first bottom and including at least two regions arranged to extend successively and vertically (or one over the other) from the first top to the first bottom, to adjoin each other, to extend over at least substantially similar heights, and to define different magnifications, providing a second planar lens defining a second top and a second bottom and having at least two regions arranged to extend successively as well as vertically (or one over the other) from the second top to the second bottom, to be adjacent to each other, to extend over the heights, and to define different magnifications, coupling the second lens to the first lens, thereby allowing lateral and vertical movement of such a second lens relative to the first lens between at least two preset positions, and arranging at least one of such regions of such a second lens to overlap one region of the first lens in one of the positions, and to translate vertically by about the similar height and to overlap a different region of the first lens in the other of such positions (in order to define different magnifications across at least a half (or a substantial portion) of such different overlapped regions of the lenses).

In another exemplary embodiment of such an aspect of the present invention, a process may include the steps of providing a first planar lens defining at least one edge and an interior surrounded by the edge and having at least two regions which may be arranged to extend successively and also radially (or angularly) about a point in the interior, to be adjacent to each other, to extend over at least substantially similar or identical angles, and to have different magnifications, providing a second planar lens defining at least one edge and an interior surrounded by the edge and having at least two regions which are arranged to extend successively and radially (or angularly) around a point in the interior, to be adjacent to each other, to extend over the angles, and to define different magnifications, movably coupling such a second lens to the first lens, thereby allowing lateral and radial (or angular) movement of the second lens with respect to the first lens between at least two preset positions, and arranging at least one of such regions of the second lens to overlap one region of the first lens in one of such positions, and then to rotate radially (or angularly) by about the angle and to overlap a different region of the first lens in the other of the positions (in order to define different magnifications across at least a half (or a substantial portion) of the different overlapped regions of the lenses).

In another exemplary embodiment of such an aspect of the present invention, a process may include the steps of providing a first planar lens forming at least one edge and an interior surrounded by such an edge and having at least two regions which may be arranged to extend successively and radially (or angularly) about a point defined along such an edge, to adjoin each other, to extend over at least substantially similar angles, and to define different magnifications, providing a second planar lens defining at least one edge and an interior surrounded by the edge and including at least two regions which may be arranged to extend successively and radially (or angularly) about a point defined along the edge, to adjoin each other, to extend over at least substantially similar or identical angles, and to define different magnifications, coupling the second lens to the first lens, thereby allowing lateral and radial (or angular) movement of the second lens relative to the first lens between at least two preset positions, and arranging at least one of the regions of such a second lens to overlap one region of the first lens in one of the positions, and to rotate radially (or angularly) by about the angle and to overlap a different region of the first lens in another of the positions (in order to define different magnifications across at least a half (or a substantial portion) of the different overlapped regions of the lenses).

In another aspect of the present invention, various multi-magnification lens assemblies may be provided by various processes.

In one exemplary embodiment of such an aspect of the present invention, such a process may include the steps of providing a first stationary lens, providing a second lens, coupling such a second lens to the first lens, thereby allowing lateral movement of such a second lens with respect to the first lens between at least two preset positions, and arranging the second lens to overlap different areas of the first lens in the positions and to define different magnifications in at least halves (or substantial portions) of the overlapped areas in at least two of the positions.

In another exemplary embodiment of such an aspect of the present invention, a process may similarly include the steps of providing a first stationary lens defining multiple regions having different magnifications, providing a second lens which may be arranged to be as large as the first lens and to include multiple regions having different magnifications, coupling such a second lens to the first lens, thereby allowing lateral movement of the second lens with respect to the first lens between at least two preset positions, and arranging the second lens to overlap different areas of the first lens in such positions and to define different magnifications across at least halves (or substantial portions) of the overlapped parts in at least two of the positions.

In another exemplary embodiment of such an aspect of the present invention, a process may include the steps of providing a first stationary lens having multiple regions at least two of which may be arranged to have different magnifications, providing a second lens arranged to be larger than such a first lens and to include multiple regions having different magnifications, coupling the second lens to the first lens, thereby allowing lateral movement of the second lens relative to the first lens between at least two preset positions, and then arranging the second lens to overlap about substantially entire portions of the first lens in the positions and to align at least one preset region of the second lens with different regions of the first lens, thereby defining different magnifications across at least halves (or substantial portions) of the entire area in at least two of the positions.

In another aspect of the present invention, various curvilinear lenses may also be provided by various processes.

In one exemplary embodiment of such an aspect of the present invention, such a process may include the steps of providing a first stationary lens and a second movable lens, movably coupling the second lens to the first lens, thereby allowing lateral movement of the second lens relative to the first lens between at least two preset positions, arranging at least one of the above lenses to define radii of curvature changing continuously along a preset direction on at least one of its surfaces, and then arranging the second lens to overlap different areas of the first lens in the positions, thereby having different magnifications in at least halves (or substantial portions) of the overlapped areas in at least two of the positions.

In another exemplary embodiment of such an aspect of the present invention, a process may include the steps of providing a first stationary lens and a second movable lens, movably coupling the second lens to the first lens, thereby allowing lateral movement of the second lens relative to the first lens between at least two preset positions, arranging each of such lenses to have radii of curvature varying continuously in a preset direction over at least one of its surfaces, and arranging the second lens to overlap different portions of the first lens in each of such positions, thereby defining different magnifications in at least halves (or substantial portions) of the overlapped areas in at least two of the positions.

In another exemplary embodiment of such an aspect of the present invention, a process may include the steps of providing a first stationary lens and a second movable lens, movably coupling the second lens to the first lens, thereby allowing lateral movement of the second lens relative to the first lens between at least two preset positions, arranging at least one of such lenses to have at least one non-circular surface, and arranging the second lens to overlap different areas of the first lens in such positions, thereby defining different magnifications in at least halves (or substantial portions) of such overlapped areas in at least two of the positions.

In another exemplary embodiment of such an aspect of the present invention, a process may include the steps of providing a first stationary lens and a second movable lens, movably coupling the second lens to the first lens, thereby allowing lateral movement of the second lens relative to the first lens between at least two preset positions, arranging at least one of the lenses to define at least one parabolic surface, and arranging the second lens to also overlap different areas of the first lens in the positions, thereby defining different magnifications in at least halves (or substantial portions) of such overlapped areas in at least two of the positions.

In another exemplary embodiment of such an aspect of the present invention, a process may include the steps of providing a first stationary lens and a second movable lens, movably coupling the second lens to the first lens, thereby allowing lateral movement of the second lens relative to the first lens between at least two preset positions, arranging at least one of the lenses to define at least one hyperbolic surface, and arranging the second lens to overlap different portions of the first lens in the positions, thereby defining different magnifications in at least halves (or substantial portions) of such overlapped areas in at least two of the positions.

In another exemplary embodiment of such an aspect of the present invention, a process may include the steps of providing a first stationary lens and a second movable lens, movably coupling the second lens to the first lens, thereby allowing lateral movement of the second lens relative to the first lens between at least two preset positions, arranging at least one of the lenses to define at least one sinusoidal surface, and arranging the second lens to overlap different portions of the first lens in such positions, thereby defining different magnifications across at least halves (or substantial portions) of the overlapped areas in at least two of the positions.

Further product-by-process claims may be constructed by combining preambles of the above apparatus claims with bodies of the above method claims. In addition, embodiments of these aspects of the present invention regarding various processes may further include one or more features which have been discussed hereinabove as well as which will be described hereinafter in conjunction with various members, various units thereof, and/or various methods to control and/or manipulate various aspects of those members and/or units of the present invention.

As used herein, a “lens” generally refers to a planar lens which has a first curvilinear surface and an opposing second curvilinear surface and which forms a curvilinear center plane between the first and second surfaces. A “first long axis” and a “second long axis” may be defined on the center plane such that the first long axis may extend linearly along the longest length, width, diagonal and/or diameter of such a center plane. The second long axis may also extend linearly along a length, width, diagonal and/or diameter of such a center plane which may be arranged to be perpendicular or normal to the first long axis. A “short axis” may be defined to be normal to the center plane and, therefore, to be normal to both of the first and second long axes. In general, the short axis generally corresponds to a thickness of the lens. It is to be understood that, when a surface of such a “lens” has a radius of curvature which is not infinite, multiple first long axes, second long axes, and/or short axes may also be defined in a single lens.

According to the foregoing definitions, a “lateral movement” as used herein generally refers to a movement along any axis defined on the center plane such as, e.g., the first long axis, second long axis, and so on. In this context, when a mobile lens is disposed in proximity to a stationary lens while opposing one surface of each lens, the “lateral movement” of the mobile lens refers to a movement of the mobile lens in a direction which is parallel with the center plane of the stationary lens, a movement of the mobile lens in a direction which is parallel with one or more of the first and/or second long axes of the stationary lens, and so on.

The “lateral movement” may denote one or more of the following movements. In one example, the “lateral movement” may refer to translation in which a starting point generally does not and cannot coincide with an ending point. In particular, a “vertical lateral movement” refers to an upward and/or downward translations, while a “horizontal lateral movement” refers to translations to the right and/or left. In another example, such a “lateral movement” may refer to rotation or revolution. In particular, an “angular or radial lateral movement” refers to rotations about at least one center point and/or plane of rotation by any angle which may be less than 360 degrees (i.e., less than a single revolution), which may be 360 degrees (i.e., a single revolution), which may be greater than 360 degrees (i.e., multiple revolutions), and the like. Distances to the center point and/or plane of rotation during such rotations may be arranged to be constant such that an ending point may coincide with a starting point through a single revolution. In the alternative, such distances may be arranged to increase or decrease so that the ending point may deviate from the starting point as the rotation proceeds.

In contrary, an “axial movement” as used herein generally refers to a movement along any axis normal or perpendicular to the center plane, the first and/or second long axes thereof, and the like. In general, the “axial movement” also refers to a movement along the short axis. In this context, when a mobile lens is disposed in proximity to a stationary lens while opposing one surface of each lens, the “axial movement” of the mobile lens refers to a movement of the mobile lens along a direction which is normal or perpendicular to the center plane of the stationary lens, a movement of the mobile lens in a direction which is parallel with the short axis of the stationary lens, and so on.

Similar to the foregoing lateral movements, the “axial movement” may also denote one or more of the following movements. In one example, the “axial movement” may refer to translation in which a starting point does not coincide with an ending point. In particular, a “vertical axial movement” refers to an upward and/or downward translations, and a “horizontal axial movement” refers to translations to the right and/or left. In another example, the “axial movement” may refer to rotation or revolution. In particular, an “angular or radial axial movement” may refer to rotations about at least one center point and/or plane of rotation by any angle which is less than 360 degrees (or a single revolution), which is 360 degrees (or a single revolution), which is greater than 360 degrees (or multiple revolutions), and the like. Distances to the center point and/or plane of rotation during such rotations may be arranged to be constant such that an ending point may coincide with a starting point through a single revolution. In the alternative, such distances may be arranged to increase or decrease so that the ending point may deviate from the starting point as the rotation proceeds.

It is appreciated that the movement of the mobile lens may be neither parallel with nor normal to the center plane. Although such a movement may be deemed part-lateral and part-axial, it is preferred that such a transverse movement be deemed to be “lateral” when an angle of deviation between such a movement and center plane does not exceed 45 degrees and to be “axial” when the deviation angle therebetween exceeds 45 degrees.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and/or advantages of the present invention will be apparent from the following detailed description, and from the claims.

### BRIEF DESCRIPTION OF THE DRAWING

FIG. 1A is a schematic diagram of exemplary lens assemblies including first lenses and second lenses where such second lenses are shaped similar to and aligned with the first lenses according to the present invention;

FIG. 1B is a schematic diagram of the exemplary lens assemblies of FIG. 1A where the second lenses are translated from the first lenses along their long axes by a preset distance according to the present invention;

FIG. 1C is a schematic diagram of exemplary lens assemblies including first lenses and second lenses where such second lenses are wider than and aligned with such first lenses according to the present invention;

FIG. 1D is a schematic diagram of the exemplary lens assemblies of FIG. 1C where the second lenses are translated from the first lenses along their long axes by a preset distance according to the present invention;

FIG. 2A is a schematic cross-sectional view of a lens assembly with a first lens defining two regions and a mobile second lens also defining two regions according to the present invention;

FIG. 2B is a schematic diagram of the lens assembly of FIG. 2A where the mobile second lens translates vertically according to the present invention;

FIG. 2C is a schematic diagram of the lens assembly of FIG. 2A where the mobile second lens translates horizontally according to the present invention;

FIG. 2D is a schematic diagram of the lens assembly of FIG. 2A where the mobile second lens rotates about a point on an edge thereof according to the present invention;

FIG. 2E is a schematic diagram of the lens assembly of FIG. 2A where the mobile second lens rotates about an interior point thereof according to the present invention;

FIG. 2F is a schematic cross-sectional view of a lens assembly with a first lens defining two regions and a mobile second lens defining an inactive region in addition to two regions and rotating or pivoting about a center according to the present invention;

FIG. 2G is a schematic cross-sectional view of a lens assembly with a first lens defining two regions and a mobile second lens defining an inactive region in addition to two regions and translating along a long axis thereof according to the present invention;

FIG. 3A is a schematic cross-sectional view of a lens assembly with a first lens defining three regions and a mobile second lens also defining three regions according to the present invention;

FIG. 3B is a schematic diagram of the lens assembly of FIG. 3A where the mobile second lens translates vertically according to the present invention;

FIG. 3C is a schematic diagram of the lens assembly of FIG. 3A where the mobile second lens translates horizontally according to the present invention;

FIG. 3D is a schematic diagram of the lens assembly of FIG. 3A where the mobile second lens rotates about a point on an edge thereof according to the present invention;

FIG. 3E is a schematic diagram of the lens assembly of FIG. 3A where the mobile second lens rotates about an interior point thereof according to the present invention;

FIG. 3F is a schematic cross-sectional view of a lens assembly with a first lens defining three regions and a mobile second lens defining an inactive region in addition to three regions and rotating or pivoting about a center according to the present invention; and

FIG. 3G is a schematic cross-sectional view of a lens assembly with a first lens defining three regions and a mobile second lens defining an inactive region in addition to three regions and pivoting or translating along a long axis thereof according to the present invention.

### DETAILED DESCRIPTION OF THE PREFERRED EMBODIMENTS

The present invention generally relates to various lenses, lens assemblies, and devices using such lenses and/or lens assemblies, to various methods of fabricating and/or using such lenses, lens assemblies, and/or devices, and to various processes of making such lenses, lens assemblies, and/or devices. More particularly, the present invention relates to various lenses which may include multiple regions at least two of which may define different magnifications therethrough. Accordingly, various lens assemblies of the present invention may include multiple lenses at least one of which may define multiple magnifications and may translate, rotate or otherwise move laterally with respect to the other lens while overlapping or aligning with different portions of the other lens and while providing uniform magnifications across preset portions of overlapped or aligned regions of the lenses. In addition, the devices of the present invention may employ such lens assemblies and provide various magnifications by moving mobile lens of the lens assembly laterally relative to stationary lenses thereof. The present invention also relates to various methods of laterally moving such mobile lenses with respect to such stationary lenses, various methods of providing or using such lenses and/or lens assemblies in order to provide multiple magnifications by laterally moving such mobile lenses in order to overlap different portions of the stationary lens, and various methods of using such mobile lenses and lenses and lens assemblies to provide multiple magnifications to various devices. The present invention further relates to various processes for providing the foregoing lenses, lens assemblies, and devices.

Various lenses and their assemblies of the present invention may be used in various devices. For example, such lenses and assemblies may be incorporated into various prescription glasses and rectify myopia, hyperopia, astigmatism, and so on. By moving mobile lenses of such assemblies and providing multiple magnifications, users may be able to identify different objects in different distances, thereby obviating to use multiple glasses. Such lenses and lens assemblies may be incorporated into sunglasses and block different amounts of light rays transmitted therethrough. Therefore, the users may use a single pair of glasses for regular viewing by disposing a mobile lens in one position, and as sunglasses by disposing the mobile lens in another position. Such lenses and assemblies may also be incorporated into various image capturing devices and/or magnifying devices and allow their users to capture and/or obtain images of objects in different magnifications. By disposing the mobile lenses in different positions, the users may capture and/or obtain the images in different magnifications without changing the lenses and/or without using conventional zoom lenses, thereby saving time for changing such lenses and saving space required to move a lens of the zoom assembly along an axial direction thereof.

Various exemplary aspects and embodiments of lens assemblies and methods of the present invention will now be described more particularly with reference to the accompanying drawings and text, where such aspects and embodiments may only represent different forms. The lens assemblies and methods of the present invention, however, may be embodied in many other different forms and, accordingly, should not be limited to such aspects and embodiments set forth herein. Rather, various exemplary aspects and embodiments of the lens assemblies and their methods described herein are provided so that the following disclosure will be thorough and complete and fully convey the scope of the present invention to one skilled in the relevant art.

Unless otherwise specified, it is to be understood that various members, elements, units, and parts of the lens assemblies are not generally drawn to scales or proportions for ease of illustration. It is also understood that the members, elements, units, and/or parts of the lens assemblies designated by the same numerals generally represent the same, similar, and/or functionally equivalent members, elements, units, and parts thereof, respectively.

In one aspect of the present invention, a lens assembly may be arranged to have at least one stationary lens and at least one mobile lens and to provide multiple magnifications according to lateral positions of the mobile lens with respect to the stationary lens. Such a lens assemblies of the present invention may be characterized by the stationary and mobile lenses each of which may define multiple regions having different magnifications and also by the mobile lenses which may be arranged to move between multiple positions defined laterally with respect to the stationary lens.

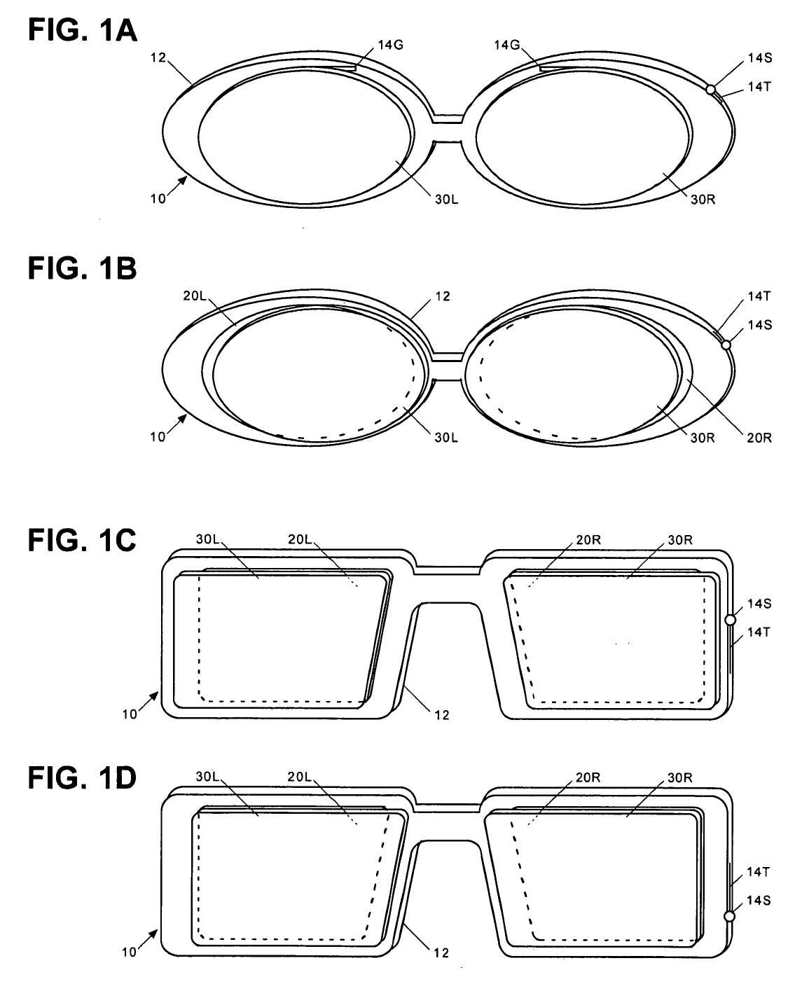

In one exemplary embodiment of such an aspect of the present invention, a lens assembly may include at least one first stationary lens and at least one second mobile lens, where the second mobile lens may be arranged move between at least two positions and to overlap or align with only a portion but not an entire portion of the first stationary lens in at least one of such positions. FIG. 1A shows a schematic diagram of exemplary lens assemblies each including a first lens and a second lens where such second lenses are shaped similar to and aligned with the first lenses, and FIG. 1B is a schematic diagram of the exemplary lens assemblies of FIG. 1A where the second lenses may translate from the first lenses along their long axes by a preset distance according to the present invention.

An exemplary pair of glasses 10 includes a frame 12 which defines a pair of legs (not shown in the figure) arranged to be disposed over ears of an user and a nose pad (not shown in the figure) arranged to support the frame 12 over a nose of the user. The frame 12 also defines a pair of holes or apertures around which a left first lens 20L and a right first lens 20R may be respectively disposed fixedly. A left second lens 30L and a right second lens 30R may be movably disposed so as to allow lateral and horizontal movements of such second lenses 30L, 30R with respect to their matching right lenses 20L, 20R. More particularly, the frame 12 includes a pair of guides 14G which are arranged to guide such second lenses 30L, 30R to move along a lateral direction with respect to such first lenses 20L, 20R while maintaining at least a substantially similar distance from the first lenses 20L, 20R. The guides 14G may also be arranged to define multiple positions in each of which the second lenses 30L, 30R may be arranged to stop and overlap (or align with) different portions of the first lenses 20L, 20R. The frame 12 may also define a track 14T and include at least one switch 14S arranged to travel along the track 14T. Such a switch 14S may preferably be arranged to operatively couple with the second lenses 30L, 30R such that the user may manipulate the switch 14S along the track 14T so as to move the second lenses 30L, 30R between their multiple positions. It is to be understood that such a pair of glasses 10 includes a pair of lens assemblies, where a left lens assembly may include the left lenses 20L, 30L, while a right lens assembly may include the right lenses 20R, 30R.

In operation, the second lenses 30L, 30R may be arranged to have at least substantially similar shapes and sizes as the first lenses 20L, 20R. Such second lenses 30L, 30R are laterally disposed in their first positions in which they generally overlap or align with entire portions of the first lenses 20L, 20R. As will be described in greater detail below, each of the first and second lenses 20L, 20R, 30L, 30R may include multiple regions having different magnifications which may be arranged such that an entire overlapping portion (or at least a substantial part thereof) of the left lenses 20L, 30L defines an effective first left magnification and an entire overlapping portion (or at least a substantial part thereof) of the right lenses 20R, 30R defines an effective first right magnification which may or may not be the same as the effective first left magnification. As the user needs different magnifications in such lens assemblies, he or she may manipulate the switch 14S along the track 14S so as to laterally move such second lenses 30L, 30R closer to each other (or inwardly). As will be described in detail below, such lateral movement may overlap different regions of such second lenses 30L, 30R with different regions of the first lenses 20L, 20R. Thus, an entire overlapping portion (or at least a substantial part thereof) of the left lenses 20L, 30L may define an effective second left magnification and an entire overlapping portion (or at least a substantial part thereof) of the right lenses 20R, 30R may also define an effective second right magnification, where such effective second magnifications may or may not be the same as the effective first magnifications. Therefore, the user may obtain different effective magnifications simply by disposing such second lenses 30L, 30R in different positions.

In another exemplary embodiment of such an aspect of the present invention, a lens assembly may similarly include at least one first stationary lens and at least one second mobile lens, where the second mobile lens may be arranged move between at least two positions and to overlap or align with an entire portion of the first stationary lens in all of such positions. FIG. 1C is a schematic diagram of exemplary lens assemblies including first lenses and second lenses where such second lenses may be wider than and aligned with such first lenses, and FIG. 1D is a schematic diagram of the exemplary lens assemblies shown in FIG. 1C where the second lenses may translate from the first lenses along their long axes by a preset distance according to the present invention.

An exemplary pair of glasses 10 is typically similar to that of FIGS. 1A and 1B, e.g., including a frame 12, a stationary first left lens 20L and a stationary first right lens 20R both fixedly incorporated into apertures of the frame 12, a mobile second left lens 30L and a mobile second right lens 30R both movably disposed with respect to the first lenses 20L, 20R, a pair of guides (not shown in the figure) along which the mobile lenses 30L, 30R may move, a switch 14S operatively coupling with the mobile lenses 30L, 30R, a track 14T along which such a switch 14S may move, and the like. Similar to those of FIGS. 1A and 1B, each lens 20L, 30L of a left lens assembly and each lens 20R, 30R of a right lens assembly may also be arranged to include multiple regions at least two of which may define different magnifications. Contrary to those of FIGS. 1A and 1B, however, the second lenses 30L, 30R may be arranged to be larger than their matching first lenses 20L, 20R.

In operation, the second lenses 30L, 30R are laterally disposed in their first positions in which they generally overlap or align with entire portions of such first lenses 20L, 20R. In particular, multiple regions of such first and second lenses 20L, 20R, 30L, 30R may preferably be arranged such that an entire overlapping portion (or at least a substantial part thereof) of the left lenses 20L, 30L defines an effective first left magnification and an entire overlapping portion (or at least a substantial part thereof) of the right lenses 20R, 30R defines an effective first right magnification which may or may not be the same as the effective first left magnification. As the user needs different magnifications in such lens assemblies, he or she may manipulate the switch 14S along the track 14S so as to laterally move such second lenses 30L, 30R closer to each other or inwardly. Such lateral movement may still allow such second lenses 30L, 30R to overlap entire portions of the first lenses 20L, 20R, but different regions of the second lenses 30L, 30R. Therefore, an entire portion (or at least a substantial part thereof of the left lenses 20L, 30L may define an effective second left magnification, whereas an entire overlapping portion (or at least a substantial part thereof of the right lenses 20R, 30R may also define an effective second right magnification, where such effective second magnifications may or may not be the same as the effective first magnifications. Therefore, the user may obtain different effective magnifications simply by disposing such second lenses 30L, 30R in different positions.

In another aspect of the present invention, a lens assembly may also be arranged to have one stationary first lens and one mobile second lens, where each of such lenses may include two regions with different magnifications and define different effective magnifications in their overlapping portions as the mobile lens may be disposed in different positions.

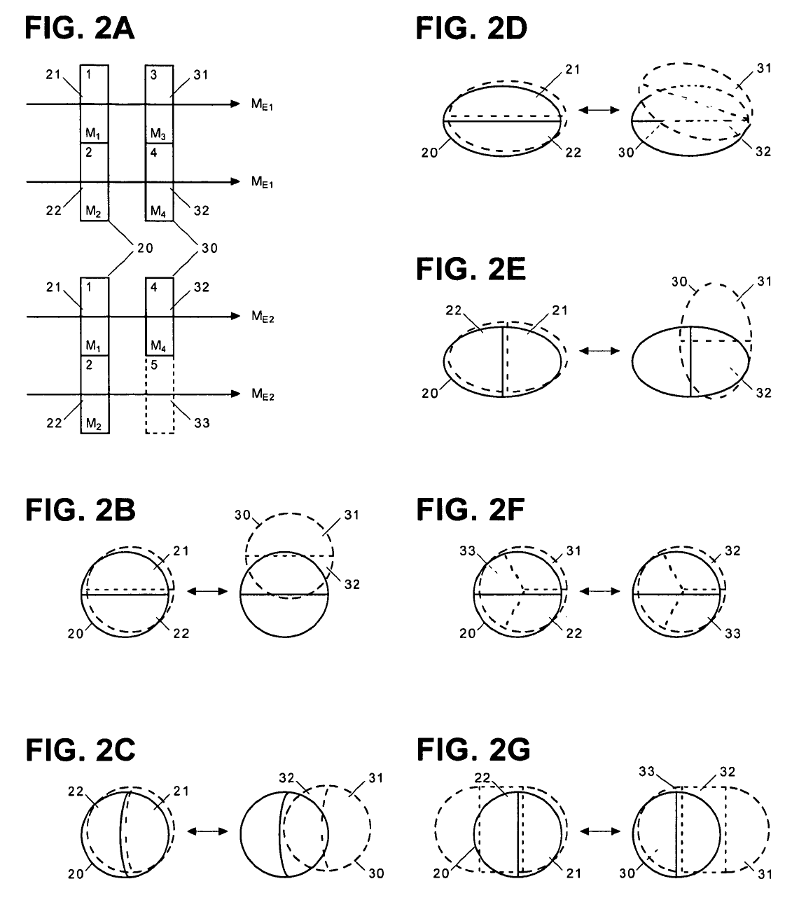

In one exemplary embodiment of such an aspect of this invention, FIG. 2A shows a schematic cross-sectional view of a lens assembly having a first lens defining two regions and a mobile second lens also defining two regions according to the present invention. An exemplary lens assembly may include a stationary or mobile first lens 20 and a second lens 30 which may be arranged to move with respect to such a first lens 20 between its first position (illustrated in the upper panel) and its second position (illustrated in the lower panel). The first lens 20 may consist of a first region 21 and a second region 22 each defining a magnification of M₁ and M₂, respectively, whereas the second lens 30 may consist of a third region 31 and a fourth region 32 each of which may define a magnification of M₃ and M₄, respectively. It is appreciated that such a figure may be interpreted as a top cross-sectional view, where the regions 21, 22, 31, 32 may be disposed side by side horizontally and extend vertically from top edges to bottom edges thereof. Alternatively, such a figure may instead be interpreted as a side cross-sectional view, where the regions 21, 22, 31, 32 may be disposed one over the other vertically and extend horizontally from left (or right) edges to right (or left) edges thereof. It is to be understood that directions and orientations of such regions 21, 22, 31, 32 may not be material to the scope of this invention as far as the following analytical algorithms are concerned.

In its first position, the second lens 30 is disposed so that its third region 31 overlaps or aligns with the first region 21 of the first lens 20 and its second region 32 overlaps or aligns with the second region 22 of the first lens 20. In addition, such first and second lenses 20, 30 may also be arranged to define identical effective magnifications M_{E1} in both overlapping regions such that the magnifications of each region 21, 22, 31, 32 may satisfy the following relationships:

M_{E1}=M₁·M₃ (1a)

M_{E1}=M₂·M₄ (1b)

In its second position, however, the second lens 30 moves to a different position with respect to the first lens 20 such that its third region 31 moves beyond the first lens 20 but its fourth region 32 overlaps or aligns with the first region 21 of the first lens 20. It is appreciated that the second lens 30 may be moved to the second position from its first position by translating and/or rotating along a length or width which may be equivalent to a length or width of the second region 22 of the first lens 20. In addition, such lenses 20, 30 may be arranged to define another identical magnifications M_{E1} in both of its overlapping and non-overlapping regions such that the magnifications of each region 21, 22, 31, 32 may satisfy the following relationships:

M_{E2}=M₁·M₄ (1c)

M_{E2}=M₂ (1d)

The target magnifications such as M_{E1} and M_{E2} are generally known values selected by an user, while the magnifications of each regions 21, 22, 31, 32 of the lenses 20, 30 such as M₁, M₂, M₃, and M₄ are to be determined so as to achieve the above target magnifications. Because the system involves four unknown values (i.e., M₁, M₂, M₃, and M₄) and the same number of equations (i.e., equations (1a) to (1d)), exact values of the unknowns may be obtained as follows:

Mₙ=M_{E2}·M_{E2}/M_{E1}=M_{E2}/r (2a)

M₂=M_{E2} (2b)

M₃=M_{E1}·M_{E1}/M_{E2}/M_{E2}=r (2c)

M₄=M_{E1}/M_{E2}=r (2d)

where a constant “r” is defined as a ratio of M_{E1} to M_{E2}. Therefore, such a lens assembly may define the first magnification, M_{E1}, in an entire area of the first lens 20 when the second lens 30 is disposed in its first position, and may then define the second magnification, M_{E2}, in the same entire area of the first lens 20 when the second lens 30 is disposed in its second position which may correspond to simply moving (i.e., translating and/or rotating) the second lens 30 by a preset distance and/or angle as will be described in greater detail below.

Configurational and/or operational variations and/or modifications of the above aspect of such an exemplary lens assembly and various lenses thereof described in FIG. 2A fall within the scope of the present invention.

First, different regions of the first and second lenses may be arranged to extend along at least one similar or identical characteristic dimension and, more particularly, in a direction along which such a second lens may be arranged to move (i.e., translate and/or rotate). Accordingly, when the second lens moves by the characteristic dimension, at least one moving region of the second lens which may originally overlap or align with a certain region of the first lens may then overlap or align with another region of the first lens which neighbors or adjoins such a certain region thereof. Alternatively, at least one of such lenses may instead have multiple regions which do not share any common characteristic dimension. When the moving region of such a second lens may extend farther than the regions of the first lens, the moving region may overlap or align with multiple regions of the first lens, thereby forming an overlapped region having a desired magnification and another overlapped region with an unwanted magnification. Conversely, when the moving region of such a second lens may extend shorter or less than the regions of the first lens, the moving region may overlap or align with only a portion of a single region of the first lens, thereby forming an overlapped region defining a desired magnification as well as a region not overlapped by such a moving region and not defining the desired magnification. As far as the non-overlapped region does not significantly interfere, such an embodiment may also be used to provide the desired magnification in at least a half or a significant portion of the first and/or second lenses.

It is to be understood that such regions of the first and second lenses may also be arranged to extend in at least substantially similar or identical dimensions along another direction which may be at least partially transverse to the direction in which such a second lens may be arranged to move (i.e., translate and/or rotate). In this embodiment, the moving region of the second lens may preferably be arranged to overlap identical lengths, widths, and/or angles of different regions of the first lens as the moving region may move between different positions, where such lengths, widths, and/or angles may be entire lengths, widths, and/or angles of at least one region of the first lens or only portions thereof. In the alternative, such regions of the first and second lenses may be arranged to extend in different dimensions along another direction which may be at least partially transverse to the direction in which such a second lens may be arranged to move (i.e., rotate and/or translate). In this embodiment, such a moving region of the second lens may preferably be arranged to overlap only a portion of different regions of the first lens or to overlap and extend beyond an entire portion of at least one region of the first lens.

As manifest in the above equations (2a) to (2d), neighboring regions of the first and/or second lenses may be arranged to define magnifications increasing or decreasing by a preset ratio such as, e.g., “r” of those equations. Therefore, the magnifications of the first and second regions of the first lens may increase by the ratio of “r” along a downward direction, while the magnifications of the third and fourth regions of the second lens may decrease by the same ratio of “r” along the same direction. When multiple regions may be formed along a radial directions, such a direction may also be defined in a clockwise or counterclockwise direction. The magnifications of such regions may then be arranged to increase by a preset ratio along one direction in one of the first and second lenses and to decrease by the same ratio along the same direction in the other of such lenses. When desirable, such regions may be defined in a non-consecutive arrangement, where magnifications of such regions may also be selected to increase or decrease by a preset ratio according to such a non-consecutive arrangement.

At least one region of the mobile second lens and/or stationary lenses may also be arranged to include at least one region which may be “inactive” in such a sense that the inactive region may define a magnification which may not follow the analytic or heuristic rule described in the above paragraph. As described hereinabove, such an inactive region may generally be used to allow the lens assembly to define an uniform magnification across at least a substantial portion of an overlapped region of the lenses. In this embodiment, such an inactive region may simply be a void or empty space formed next to one region of the lens. Alternatively, such an inactive region may be made of and/or include a plain transparent material having a magnification of 1.0 or a magnification close thereto. In this embodiment, overlapping of the inactive region with a region of another lens may provide an effective magnification which may be the same as the magnification of such a region of another lens. In another alternative, such an inactive region may instead be arranged to define a magnification which does not follow such an analytical or heuristic rule. Because the inactive region may alter an effective magnification of the lens assembly from a pattern of magnifications according to such a rule, such an inactive region may not be recruited to provide an uniform magnification across an overlapped or aligned portion of such lenses.

It is appreciated that various embodiments described in the foregoing four paragraphs may be also applied to other aspects and/or embodiments of various lenses, lens assemblies employing such lenses, and/or various image generating, acquiring, and/or magnifying devices employing such lenses and/or lens assemblies of the present invention, unless otherwise specified.

In another aspect of the present invention, such a lens assembly constructed according to the foregoing relationships of (2a) to (2d) may be embodied in various configurations so that the first and second lenses may be disposed in various orientations and that the second lens may be arranged to move in various directions along various curvilinear paths. Following FIGS. 2B through 2G exemplify several embodiments of such lens assemblies and their lenses.

In one exemplary embodiment of such an aspect of the present invention, FIG. 2B represents a schematic diagram of the lens assembly of FIG. 2A where the mobile second lens translates vertically according to the present invention. An exemplary lens assembly includes a first lens 20 and a second lens 30, where the former 20 forms an upper first region 21 and a lower second region 22, while the latter 30 defines an upper third region 31 and a lower fourth region 32.

In one position as described in the left panel of FIG. 2B, the second lens 30 may be arranged to overlap (or align with) at least a substantially entire area of the first lens 20 while overlapping its third and fourth regions 31, 32 with the first and second regions 21, 22 of the first lens 20, respectively. It is appreciated that magnifications of the regions 21, 22, 31, 32 may preferably be arranged to satisfy the relations of (2a) to (2d) such that at least a substantial area of overlapped portions of the first and second lenses 20, 30 may be able to define an uniform magnification such as, M_{E1}, thereacross.

In another position as exemplified in the right panel of FIG. 2B, the second lens 30 may then be arranged to translate linearly and vertically with respect to the first lens 20 by approximately a height of the first lens 20 in an upward direction. Therefore, at least a substantial portion of the third region 31 of the second lens 30 may be disposed beyond an upper edge of the first lens 20, while at least a substantial area of the fourth region 32 of the second lens 30 may overlap or align with the first region of the first lens 20. As exemplified in the figure, such a second region 22 of the first lens 20 may not be overlapped by or aligned with any region of the second lens 30 or, in the alternative, by an inactive region of the second lens 30 which has been described above. Therefore, at least a substantial area of the first lens 20 may be able to define thereacross an uniform magnification such as, M_{E2}, according to the above relations (2a) to (2d).

In another exemplary embodiment of such an aspect of the present invention, FIG. 2C shows a schematic diagram of the lens assembly of FIG. 2A where the second lens may translate horizontally according to the present invention. An exemplary lens assembly includes a first lens 20 and a second lens 30, where the former 20 forms a first region 21 on its right side and a second region 22 on its left side, whereas the latter 30 defines a third region 31 on its right side and a fourth region 32 on its right side.

In one position as described in the left panel of FIG. 2C, the second lens 30 may be arranged to overlap (or align with) at least a substantially entire area of the first lens 20 while overlapping its third and fourth regions 31, 32 with the first and second regions 21, 22 of the first lens 20, respectively. It is appreciated that magnifications of the regions 21, 22, 31, 32 may preferably be arranged to satisfy the relations of (2a) to (2d) such that at least a substantial area of overlapped portions of the first and second lenses 20, 30 may be able to define an uniform magnification such as, M_{E1}, thereacross.

In another position as shown in the right panel of FIG. 2C, the second lens 30 may be arranged to translate linearly and horizontally with respect to the first lens 20 by approximately a width of such a first lens 20 to the right. Therefore, at least a substantial portion of the third region 31 of the second lens 30 may be disposed beyond a right edge of the first lens 20, whereas at least a substantial area of the fourth region 32 of the second lens 30 may overlap or align with the first region of the first lens 20. Similar to that of FIG. 2B, such a second region 22 of the first lens 20 may not be overlapped by or aligned with any region of the second lens 30 or, alternatively, by an inactive region of the second lens 30 which has been described above. Accordingly, at least a substantial area of the first lens 20 may be able to define thereacross an uniform magnification such as, M_{E2}, as exemplified by the above relations (2a) to (2d).

In another exemplary embodiment of such an aspect of the present invention, FIG. 2D shows a schematic diagram of the lens assembly of FIG. 2A where the second lens may rotate around a point on an edge thereof according to the present invention. Similar to that shown in FIG. 2B, an exemplary lens assembly includes a first lens 20 forming an upper first region 21 and a lower second region 22 and a second lens 30 defining an upper third region 31 and a lower fourth region 32.

In one position as described in the left panel of FIG. 2D, the second lens 30 may be arranged to overlap (or align with) at least a substantially entire area of the first lens 20 while overlapping its third and fourth regions 31, 32 with the first and second regions 21, 22 of the first lens 20, respectively. It is appreciated that magnifications of the regions 21, 22, 31, 32 may preferably be arranged to satisfy the relations of (2a) to (2d) such that at least a substantial area of overlapped portions of the first and second lenses 20, 30 may be able to define an uniform magnification such as, M_{E1}, thereacross.

In another position as exemplified in the right panel of FIG. 2D, the second lens 30 may then be arranged to rotate (or pivot) angularly with respect to the first lens 20 by approximately 45 degrees in a clockwise direction about a center of rotation which is provided on a right edge of the first lens 20. Accordingly, at least one half (or more) of the third region 31 of the second lens 30 may be displaced beyond an upper edge of the first lens 20, whereas at least one half (or more) of the fourth region 32 of the second lens 30 may overlap or align with the first region of the first lens 20. Similar to those of FIGS. 2B and 2C, the second region 22 of the first lens 20 may not be overlapped by (or aligned with) any region of the second lens 30 or, alternatively, by an inactive region of the second lens 30 which has been described above. Accordingly, at least a substantial area of the first lens 20 may be able to define thereacross an uniform magnification such as, M_{E2}, as exemplified by the above relations (2a) to (2d).

In another exemplary embodiment of such an aspect of the present invention, FIG. 2E shows a schematic diagram of the lens assembly shown in FIG. 2A where the second lens may rotate around an interior point thereof according to the present invention. Similar to that shown in FIG. 2C, such an exemplary lens assembly may include a first lens 20 defining a first region 21 on its right side and a second region 22 on its left side as well as a second lens 30 defining a third region 31 on its right side and a fourth region 32 on its left side.

In one position as described in the left panel of FIG. 2E, the second lens 30 may be arranged to overlap (or align with) at least a substantially entire area of the first lens 20 while overlapping its third and fourth regions 31, 32 with the first and second regions 21, 22 of the first lens 20, respectively. It is appreciated that magnifications of the regions 21, 22, 31, 32 may preferably be arranged to satisfy the relations of (2a) to (2d) such that at least a substantial area of overlapped portions of the first and second lenses 20, 30 may be able to define an uniform magnification such as, M_{E1}, thereacross.

In another position as exemplified in the right panel of FIG. 2E, the second lens 30 may then be arranged to rotate (or pivot) angularly with respect to the first lens 20 by approximately 45 degrees in a counterclockwise direction about a center of rotation which may be provided on a center portion of an upper edge of the first lens 20. Accordingly, at least one half (or more) of the third region 31 of the second lens 30 may be displaced beyond an upper edge of the first lens 20, while at least one half or more of the fourth region 32 of the second lens 30 may overlap or align with the first region of the first lens 20. Similar to those shown in FIGS. 2B to 2D, the second region 22 of the first lens 20 may not be overlapped by (or aligned with) any region of the second lens 30 or, in the alternative, by an inactive region of the second lens 30 as described above. Accordingly, at least a substantial area of the first lens 20 may be able to define thereacross an uniform magnification such as, M_{E2}, as exemplified by the above relations (2a) to (2d).

In another exemplary embodiment of such an aspect of the present invention, FIG. 2F shows a schematic cross-sectional view of a lens assembly with a first lens and a mobile second lens, where the first lens defines two regions and where the second lens defines an inactive region in addition to two regions and rotating or pivoting about a center according to the present invention. An exemplary lens assembly includes a first lens 20 and a second lens 30, where the former 20 forms an upper first region 21 and a lower second region 22, whereas the latter 30 forms a third region 31, a fourth region 32, and an inactive region 33. An unique feature of the lenses of this embodiment is that their lenses may have different numbers of regions and that at least one region of one lens of the lens assembly may be arranged to define a shape and/or a size which may be different from a shape and/or size of at least one region of another lens of such a lens assembly. Therefore, it is appreciated that a smaller region of one (or another) lens may only overlap a portion of a larger (or smaller) region of another (or one) lens and that such a larger lens of another (or one) lens may be covered by at least two smaller regions of such one (or another) lens.

In one position as described in the left panel of FIG. 2F, the second lens 30 may be arranged to overlap (or align with) at least a substantially entire portion of the first lens 20 while overlapping right sides of the first and second regions 21, 22 of the first lens 20 with its third and fourth regions 31, 32, respectively, and while overlapping left sides of such first and second regions 21, 22 by its inactive region 33. Magnifications of the regions 21, 22, 31, 32, 33 may preferably be arranged to satisfy the relations of (2a) through (2d) so that at least two thirds of overlapped portions of the first and second lenses 20, 30 on their right sides may define an uniform magnification such as, M_{E1}, thereacross. The remaining one third of the portions of the first and second lenses 20, 30 which may be overlapped by the inactive region 33 may or may not be able to define the same magnification, M_{E1}, depending upon a magnification of the inactive region 33 of the second lens 20.

In another position as shown in the right panel of FIG. 2F, the second lens 30 may be arranged to rotate or pivot radially with respect to the first lens 20 by about 120 degrees in a counterclockwise direction about a center of rotation which may be provided in a center of the first lens 20. Therefore, at least a substantial portion (or area) of the fourth region 32 of such a second lens 30 may overlap or align with the right side of the first region 21 of the first lens 20, while at least a substantial portion (or area) of the inactive region 33 of the second lens 30 may overlap or align with the right side of such a second region 22 of the first lens 20. Therefore, at least a substantial area of the first lens 20 except the left side may be able to define thereacross an uniform magnification such as, M_{E2}, according to the above relations (2a) to (2d). The remaining one third of the portions of the first and second lenses 20, 30 overlapped by the inactive region 33 may or may not be able to define the same magnification, M_{E2}, depending upon a magnification of the inactive region 33 of the second lens 20.

In another exemplary embodiment of such an aspect of the present invention, FIG. 2G shows a schematic cross-sectional view of a lens assembly with a first lens and a mobile second lens, where the first lens defines two regions and where second lens defines an inactive region in addition to two regions and translating along its long axis according to the present invention. Such an exemplary lens assembly includes a first lens 20 and a second lens 30, where the former 20 forms a first region 21 on its right side and a second region 22 on its left side, whereas the latter 30 defines a third region 31 on its right side, an inactive region 33 on its left side, and a fourth region 32 in its center and between such third and inactive regions 31, 33.

In one position as depicted in the left panel of FIG. 2G, the second lens 30 may be arranged to overlap or align with at least a substantially entire portion or area of the first lens 20 while overlapping (or aligning) its third and fourth regions 31, 32 respectively with the first and second regions 21, 22 of the first lens 20 and while disposing at least a substantial portion or area of the inactive region beyond an left edge of the first lens 20. As described above, magnifications of the regions 21, 22, 31, 32 may preferably be arranged to satisfy the relations of (2a) through (2d) so that at least a substantial area of overlapped portions of the first lens 20 may be able to define an uniform magnification such as, M_{E1}, thereacross. The remaining inactive region 33 of the second lens 30 which may not overlap (or align with) the first lens due to its greater size, and may or may not be able to have the same magnification, M_{E1}, as the rest of the second lens 30 depending upon a magnification thereof.

In another position as shown in the right panel of FIG. 2G, the second lens 30 may be arranged to translate linearly and horizontally with respect to the first lens 20 by approximately a length or width of a region of the first lens 20 to the right. As a result, at least a substantial portion of the third region 31 of the second lens 30 may be disposed beyond a right edge of such a first lens 20, while at least a substantial portion or area of the fourth region 32 of the second lens 30 may overlap or align with the first region of the first lens 20 and while at least a substantial portion or area of the inactive region 33 of the second lens may overlap or align with the second region 22 of the first lens 20. As described above, magnifications of the regions 21, 22, 32, 33 may preferably be arranged to satisfy the relations of (2a) through (2d) so that at least a substantial area of overlapped portions of the first lens 20 may be able to define an uniform magnification such as, M_{E2}, thereacross. Therefore, at least a substantial portion (or area) of the first lens 20 may be able to define thereacross an uniform magnification such as, M_{E2}, as exemplified by the above relations (2a) to (2d). The remaining third region 31 of the longer or wider second lens 30 which may not overlap (or align with) the first lens may or may not be able to have the same magnification, M_{E1}, as the rest of the second lens 30 depending upon its magnification.

In another aspect of the present invention, a lens assembly may also be arranged to have one stationary first lens and one mobile second lens, where each of the lenses may include three regions with different magnifications and define different effective magnifications in their overlapping portions as the mobile lens may be disposed in different positions.

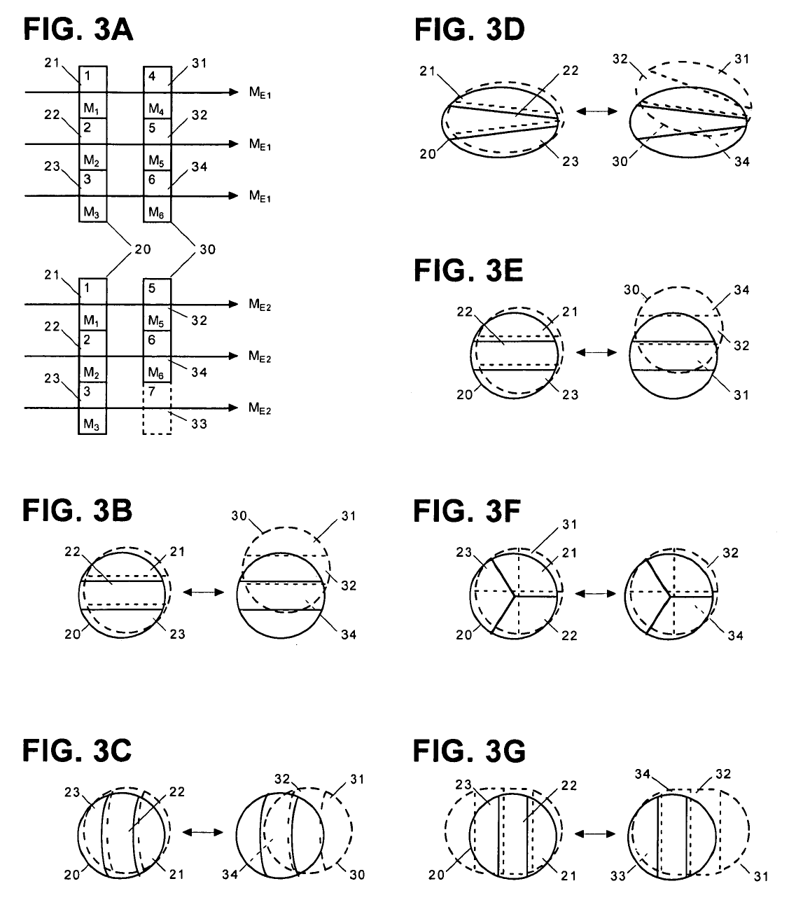

In one exemplary embodiment of such an aspect of this invention, FIG. 3A shows a schematic cross-sectional view of a lens assembly having a first lens forming three regions and a mobile second lens also defining three regions according to the present invention. An exemplary lens assembly may include a stationary or mobile first lens 20 and a second lens 30 which may be arranged to move with respect to such a first lens 20 between its first position (illustrated in the upper panel) and its second position (illustrated in the lower panel). The first lens 20 may have a first region 21, a second region, and a third region 23 defining magnifications of M₁, M₂, and M₆, respectively, while the second lens 30 may consist of a fourth region 31, a fifth region 32, and a sixth region 33 defining magnifications of M₃, M₄, and M₆, respectively. It is appreciated, similar to FIG. 2A, that FIG. 3A may also be interpreted as a top cross-sectional view, where various regions 21, 22, 23, 31, 32, 33 may be disposed side by side horizontally and extend vertically from top edges to bottom edges thereof. Alternatively, such a figure may instead be interpreted as a side cross-sectional view, in which the regions 21, 22, 23, 31, 32, 33 may be disposed one over the other vertically and extend horizontally from left (or right) edges to right (or left) edges thereof. It is to be understood that directions and orientations of the regions 21, 22, 23, 31, 32, 33 may not be material to the scope of the present invention as long as the following analytical algorithms are concerned.

In its first position, the second lens 30 may be disposed so that its fourth region 31 overlaps or aligns with the first region 21 of the first lens 20, its fifth region 32 overlaps or aligns with the second region 22 of the first lens 20, and its sixth region 33 overlaps or aligns with the third region 23 of the first lens 20. In addition, such first and second lenses 20, 30 may also be arranged to define identical effective magnifications M_{E1} in all overlapping regions such that the magnifications of each overlapping pair of regions such as, e.g., 21 and 31, 22 and 32, 23 and 33, may satisfy the following relationships:

M_{E1}=M₁·M₄ (3a)

M_{E1}=M₂·M₅ (3b)

M_{E1}=M₃·M₆ (3c)

In its second position, however, the second lens 30 moves to a different position with respect to the first lens 20 such that its fourth region 31 moves beyond the first lens 20 but its fifth region 32 overlaps or aligns with the first region 21 of the first lens 20 and its sixth region 33 overlaps or aligns with the second region 22 of the first lens 20. It is appreciated that the second lens 30 may be moved to the second position from its first position, e.g., by translating and/or rotating along a length or width which may be equivalent to a length or width of the first and/or second regions 22, 23 of the first lens 20. In addition, such first and second lenses 20, 30 may also be arranged to define another identical magnifications M_{E2} in all of its overlapping and non-overlapping regions such that the magnifications of each overlapping pair of regions such as, e.g., 21 and 31, 22 and 32, and 23 and 33 may satisfy the following relationships:

M_{E2}=M₁·M₅ (3d)

M_{E2}=M₂·M₆ (3e)

M_{E2}=M₃ (3f)

The target magnifications such as M_{E1} and M_{E2} are generally known values selected by an user, while the magnifications of each region 21, 22, 23, 31, 32, 33 of the lenses 20, 30 such as M₁, M₂, M₃, M₄, M₅, and M₆ are to be determined in order to achieve the above target magnifications. Because the system involves six unknown values (i.e., M₁, M₂, M₃, M₄, M₅, and M₆) as well as the same number of equations (i.e., equations (3a) to (3f)), exact values of the unknowns may be obtained as follows:

M₁=M_{E2}·M_{E2}·M_{E2}/M_{E1}/M_{E1}/M_{E2}/r² (4a)

M₂=M_{E2}·M_{E2}/M_{E1}=M_{E2}/r (4b)

M₃=M_{E2} (4c)

M₄=M_{E1}·M_{E1}·M_{E1}/M_{E2}/M_{E2}/M_{E2}=r² (4d)

M₅=M_{E1}·M_{E1}/M_{E2}/M_{E2}=r² (4e)

M₆=M_{E1}/M_{E2}=r (4f)

where a constant “r” is defined as a ratio of M_{E1} to M_{E2}. Therefore, such a lens assembly may define the first magnification, M_{E1}, in an entire area of the first lens 20 when the second lens 30 is disposed in its first position, and may then define the second magnification, M_{E2}, in the same entire area of the first lens 20 when the second lens 30 is disposed in its second position which may correspond to simply moving (i.e., translating and/or rotating) the second lens 30 by a preset distance and/or angle as will be described in greater detail below.

Configurational and/or operational variations and/or modifications of the above aspect of such an exemplary lens assembly and various lenses thereof described in FIG. 3A fall within the scope of the present invention.

First, different regions of the first and second lenses may be arranged to extend along at least one similar or identical characteristic dimension and, more particularly, in a direction along which such a second lens may be arranged to move (i.e., translate and/or rotate). Therefore, as the second lens moves by the characteristic dimension, at least two moving regions of such a second lens which may originally overlap or align with certain regions of the first lens may then overlap or align with other two regions of the first lens which neighbor or adjoin such certain regions thereof. Alternatively, at least one of such lenses may instead have multiple regions which do not share any common characteristic dimension. When the moving region of such a second lens may extend farther than the regions of the first lens, the moving region may overlap or align with multiple regions of the first lens, thereby forming an overlapped region having a desired magnification and another overlapped region with an unwanted magnification. Conversely, when the moving region of such a second lens may extend shorter or less than the regions of the first lens, the moving region may overlap or align with only a portion of a single region of the first lens, thereby forming an overlapped region defining a desired magnification as well as a region not overlapped by such a moving region and not defining the desired magnification. As far as the non-overlapped region does not significantly interfere, such an embodiment may also be used to provide the desired magnification in at least a half or a significant portion of the first and/or second lenses.

It is to be understood that such regions of the first and second lenses may also be arranged to extend in at least substantially similar or identical dimensions along another direction which may be at least partially transverse to the direction in which such a second lens may be arranged to move (i.e., translate and/or rotate). In this embodiment, the moving region of the second lens may preferably be arranged to overlap identical lengths, widths, and/or angles of different regions of the first lens as the moving region may move between different positions, where such lengths, widths, and/or angles may be entire lengths, widths, and/or angles of at least one region of the first lens or only portions thereof. In the alternative, such regions of the first and second lenses may be arranged to extend in different dimensions along another direction which may be at least partially transverse to the direction in which such a second lens may be arranged to move (i.e., rotate and/or translate). In this embodiment, such a moving region of the second lens may preferably be arranged to overlap only a portion of different regions of the first lens or to overlap and extend beyond an entire portion of at least one region of the first lens.

As manifest in the above equations (4a) to (4f), neighboring regions of the first and/or second lenses may be arranged to define magnifications increasing or decreasing by a preset ratio such as, e.g., “r” of those equations. Therefore, the magnifications of the first, second, and third regions of the first lens may increase by the ratio of “r” along a downward direction, whereas the magnifications of the fourth, fifth, and sixth regions of the second lens may decrease by the same ratio of “r” along the same direction. When multiple regions may be formed along a radial direction, such a direction may be defined in either a clockwise direction or a counterclockwise direction. Magnifications of such radial regions may be arranged to increase by a preset ratio along one direction in one of such lenses, and to decrease by the same ratio in the same direction in another of such lenses. When desirable, such regions may be defined in a non-consecutive arrangement, where magnifications of such regions may be similarly selected to increase or decrease by a preset ratio according to such a non-consecutive arrangement.

At least one region of the mobile second lens and/or stationary lenses may also be arranged to have at least one inactive region as discussed above. The inactive region may be a void space or an empty space capable of defining uniform magnifications across at least substantial portions of regions overlapped by the lenses. In the alternative, the inactive region may be made of and/or include a plain transparent material having a magnification of 1.0 or a magnification close thereto so as to provide an effective magnification which may be the same as the magnification of such a region of another lens. In another alternative, such an inactive region may be arranged to define a magnification which does not follow the above analytical or heuristic rule, where such an inactive region may not be recruited to provide an uniform magnification across an overlapped or aligned portion of the lenses as discussed above.

It is appreciated that various embodiments described in the foregoing four paragraphs may be also applied to other aspects and/or embodiments of various lenses, lens assemblies employing such lenses, and/or various image generating, acquiring, and/or magnifying devices employing such lenses and/or lens assemblies of the present invention, unless otherwise specified.

In another aspect of the present invention, such a lens assembly constructed according to the foregoing relationships of (4a) to (4f) may be embodied in various configurations so that the first and second lenses may be disposed in various orientations and that the second lens may be arranged to move in various directions along various curvilinear paths. Following FIGS. 3B to 3G exemplify several embodiments of such lens assemblies and their lenses.

In another exemplary embodiment of such an aspect of the present invention, FIG. 3B shows a schematic diagram of the lens assembly of FIG. 3A where the mobile second lens translates vertically according to the present invention. An exemplary lens assembly includes a first lens 20 and a mobile second lens 30 arranged to move with respect to the first lens 20, where the former 20 may form an upper first region 21, a middle second region 22, and a lower third region 23, while the latter 30 forms an upper fourth region 31, a middle fifth region 32, and a lower sixth region 34.

In one position as described in the left panel of FIG. 3B, the second lens 30 may be arranged to overlap or align with at least a substantially entire portion or area of the first lens 20 while overlapping or aligning its fourth, fifth, and sixth regions 31, 32, 33 with the first, second, and third regions 21-23 of the first lens 20, respectively. It is appreciated that magnifications of the regions 21-23, 31, 32, 34 may preferably be arranged to meet the relations of (4a) to (4f) so that at least a substantial portion or area of overlapped portions of the first and second lenses 20, 30 may define an uniform magnification such as, M_{E1}, thereacross.

In another position as exemplified in the right panel of FIG. 3B, the second lens 30 may then be arranged to translate linearly and vertically with respect to the first lens 20 by about a height of one of the regions 21-23 of the first lens 20 in an upward direction. Therefore, at least a substantial portion or area of the fourth region 31 of the second lens 30 may be positioned beyond an upper edge of the first lens 20, whereas at least a substantial portion or area of the fifth region 32 of the second lens 30 may overlap or align with the first region of the first lens 20 and at least a substantial portion or area of the sixth region 34 of the second lens 30 may overlap or align with the second region 22 of the first lens 20. Accordingly, at least a substantial area of the first lens 20 may be able to define thereacross an uniform magnification such as, M_{E2}, according to the above relations (4a) to (4f). As exemplified in the above figure, the third region 23 of the first lens 20 may not be overlapped by or aligned with any region of the second lens 30 or, alternatively, by an inactive region of the second lens 30 (not shown in the above figure) as described above.

In another exemplary embodiment of such an aspect of the present invention, FIG. 3C shows a schematic diagram of the lens assembly of FIG. 3A where the second lens may translate horizontally according to the present invention. An exemplary lens assembly includes a first lens 20 and a mobile second lens 30 arranged to move with respect to the first lens 20, in which the former 20 may form a first region 21 on its left side, a third region 23 on its right side, and a second region 22 between such first and third regions 21, 23, while the latter 30 may define a fourth region 31 on its right side, a sixth region 34 on its left side, and a fifth region 32 between such fourth and sixth regions 31, 34.

In one position as described in the left panel of FIG. 3C, the second lens 30 may be arranged to overlap or align with at least a substantially entire portion or area of the first lens 20 while overlapping or aligning its fourth, fifth, and sixth regions 31, 32, 33 with the first, second, and third regions 21-23 of the first lens 20, respectively. It is appreciated that magnifications of the regions 21-23, 31, 32, 34 may preferably be arranged to meet the relations of (4a) to (4f) so that at least a substantial portion or area of overlapped portions of the first and second lenses 20, 30 may define an uniform magnification such as, M_{E1}, thereacross.

In another position as exemplified in the right panel of FIG. 3C, the second lens 30 may then be arranged to translate linearly and horizontally with respect to the first lens 20 by about a length and/or width of one of the regions 21-23 of the first lens 20 along an upward direction. Accordingly, at least a substantial portion or area of the fourth region 31 of the second lens 30 may be disposed beyond a right edge of the first lens 20, while at least a substantial portion or area of the fifth region 32 of the second lens 30 may overlap or align with the first region of the first lens 20 and at least a substantial portion or area of the sixth region 34 of the second lens 30 may then overlap or align with the second region 22 of the first lens 20. Therefore, at least a substantial area of the first lens 20 may be able to define thereacross an uniform magnification such as, M_{E2}, according to the foregoing relations (4a) to (4f). As exemplified in the above figure, the third region 23 of the first lens 20 may not be overlapped by or aligned with any region of the second lens 30 or, in the alternative, by an inactive region of the second lens 30 (not shown in the above figure) as described above.

In another exemplary embodiment of such an aspect of the present invention, FIG. 3D shows a schematic diagram of the lens assembly of FIG. 3A where the second lens may rotate around a point on an edge thereof according to the present invention. Similar to that shown in FIG. 3B, an exemplary lens assembly may include a first lens 20 and a second lens 30, where the first lens 20 may have an upper first region 21, a middle second region 22, and a lower third region 23, while the second lens 30 may define an upper fourth region 31, a middle fifth region 32, and a lower sixth region 34. Contrary to that of FIG. 3B, such regions 21-23, 31, 32, 34 may preferably be arranged to have arcuate shapes which may extend from right sides of such lenses 20, 30.

In one position as described in the left panel of FIG. 3D, the second lens 30 may be arranged to overlap (or align with) at least a substantially entire area of the first lens 20 while overlapping its first, second, and third regions 21-23 with the fourth, fifth, and sixth regions 31, 32, 34 of the second lens 30, respectively. It is appreciated that magnifications of the regions 21-23, 31, 32, 34 may preferably be arranged to meet the relations of (3a) through (3f) so that at least a substantial area of overlapped portions of the first and second lenses 20, 30 may be able to define an uniform magnification such as, M_{E1}, thereacross.

In another position as exemplified in the right panel of FIG. 3D, the second lens 30 may then be arranged to rotate (or pivot) angularly with respect to the first lens 20 by approximately 30 degrees in a clockwise direction about a center of rotation which is provided on a right edge of the first lens 20. Therefore, at least a substantial portion of the fourth region 31 of the second lens 30 may be disposed beyond an upper edge of the first lens 20, while at least one half (or more) of the fifth region 32 of the second lens 30 may overlap or align with the first region of the first lens 20 and while at least one half (or more) of the sixth region 34 of the second lens 30 may overlap or align with the second region of the first lens 20. Similar to those of FIGS. 3B and 3C, the third region 23 of the first lens 20 may not be overlapped by or aligned with any region of the second lens 30 or, alternatively, by an inactive region of the second lens 30 which has been described above. Therefore, at least a substantial area of the first lens 20 may be able to define thereacross an uniform magnification such as, M_{E2}, as exemplified by the above relations (3a) to (3f).

In another exemplary embodiment of such an aspect of the present invention, FIG. 3E shows a schematic diagram of the lens assembly of FIG. 3A where the second lens rotates around an interior point thereof according to the present invention. An exemplary lens assembly may include a first lens 20 and a second lens 30. Similar to those of FIG. 3B, the first lens 20 may define an upper first region 21, a middle second region 22, and a lower third region 23, whereas the second lens 30 may have an upper fourth region 31, a middle fifth region 32, and a lower sixth region 34.

In one position as described in the left panel of FIG. 3E, the second lens 30 may be arranged to overlap (or align with) at least a substantially entire area of the first lens 20 while overlapping its first, second, and third regions 21-23 with the fourth, fifth, and sixth regions 31, 32, 34 of the second lens 30, respectively. It is appreciated that magnifications of the regions 21-23, 31, 32, 34 may preferably be arranged to meet the relations of (3a) through (3f) so that at least a substantial area of overlapped portions of the first and second lenses 20, 30 may be able to define an uniform magnification such as, M_{E1}, thereacross.

In another position as exemplified in the right panel of FIG. 3E, the second lens 30 may then be arranged to rotate (or pivot) angularly with respect to the first lens 20 by approximately 30 degrees in a clockwise direction about a center of rotation which is defined on a center along a border between the first and second regions 21, 22 of the first lens 20. Therefore, at least a substantial portion of the sixth region 31 of the second lens 30 may be disposed above an upper edge of the first lens 20, while at least one half (or more) of the fifth region 32 of the second lens 30 may overlap or align with such a first region 21 of the first lens 20 and while at least one half (or more) of the sixth region 34 of such a second lens 30 may overlap or align with the second region 22 of the first lens 20. Similar to those of FIGS. 3B to 3D, the third region 23 of the first lens 20 may not be overlapped by or aligned with any region of the second lens 30 or, alternatively, by an inactive region of the second lens 30 which has been described above. Therefore, at least a substantial area of the first lens 20 may be able to define thereacross an uniform magnification such as, M_{E2}, as exemplified by the above relations (3a) to (3f). It is appreciated that individual magnifications of the above regions 21-23, 31, 32, 34 may also become slightly different from those of equations (3a) to (3f) due to different arrangements of the regions 31, 32, 34 of the second lens 30 in its rotated or pivoted position. However, such magnifications may be readily determined by applying the same methods as described in conjunction with FIG. 3A.

In another exemplary embodiment of such an aspect of the present invention, FIG. 3F shows a schematic cross-sectional view of a lens assembly with a first lens and a mobile second lens, where the first lens defines three regions and where the second lens defines an inactive region in addition to three regions and rotating or pivoting about a center according to the present invention. An exemplary lens assembly includes a first lens 20 and a second lens 30, where the first lens 20 may define a first region 21, a second region 22, and a third region 23 radially (or angularly) along a clockwise direction, while the second lens 30 forms a fourth region 31, a fifth region 32, a sixth region 34, and an inactive region 33 along a clockwise direction. An unique feature of the lenses of this embodiment is that their lenses may have different numbers of regions and that at least one region of one lens 20, 30 of such a lens assembly may have a shape and/or a size which may be different from a shape and/or size of at least one region of another lens 30, 20 of such a lens assembly. Accordingly, it is appreciated that a smaller region of one (or another) lens may only overlap a portion of a larger (or smaller) region of another (or one) lens and that such a larger lens of another (or one) lens may be covered by at least two smaller regions of such one (or another) lens.

In one position as described in the left panel of FIG. 3F, the second lens 30 may be arranged to overlap (or align with) at least a substantially entire portion of the first lens 20 while overlapping right sides of the first and second regions 21, 22 of the first lens 20 with its fourth and fifth regions 31, 32, respectively, and while overlapping left sides of such first and second regions 21, 22 and an entire region of the third region 33 by its sixth and inactive regions 34, 33. Magnifications of the regions 21-23, 31-34 may preferably be arranged to satisfy the relations of (3a) through (3f) so that at least two thirds of overlapped portions of such lenses 20, 30 may define an uniform magnification such as, M_{E1}, thereacross. The remaining portion of such lenses 20, 30 which may be overlapped or aligned by the inactive region 33 may or may not be able to define the same magnification, M_{E1}, thereacross, similar to those shown in FIGS. 2F and 2G, depending upon a magnification of such an inactive region 33 of the second lens 20.

In another position as shown in the right panel of FIG. 2F, the second lens 30 may be arranged to rotate or pivot radially with respect to the first lens 20 by about 120 degrees in a counterclockwise direction about a center of rotation which may be provided in a center of the first lens 20. Therefore, at least a substantial portion (or area) of the fourth region 32 of such a second lens 30 may overlap or align with the right side of the first region 21 of the first lens 20, while at least a substantial portion (or area) of the inactive region 33 of the second lens 30 may overlap or align with the right side of such a second region 22 of the first lens 20. Therefore, at least a substantial area of the first lens 20 except the left side may be able to define thereacross an uniform magnification such as, M_{E2}, according to the above relations (2a) to (2d). The remaining one third of the portions of the first and second lenses 20, 30 overlapped by the inactive region 33 may or may not be able to define the same magnification, M_{E2}, depending upon a magnification of the inactive region 33 of the second lens 20.

In another exemplary embodiment of such an aspect of the present invention, FIG. 3G shows a schematic cross-sectional view of a lens assembly with a first lens and a mobile second lens, where the first lens defines three regions and where the second lens defines an inactive region in addition to three regions and pivoting or translating along a long axis thereof according to the present invention. An exemplary lens assembly may include a first lens 20 and a second lens 30, where the first lens 20 may form a first region 21 on its right side, a third region 23 on its left side, and a middle second region 22 between the first and third regions 21, 23, while the second lens 30 may define a fourth region 31, a fifth region 32, a sixth region 34, and an inactive region 33 side by side from right to left.

In one position as depicted in the left panel of FIG. 3G, the second lens 30 may be arranged to overlap or align with at least a substantially entire portion or area of the first lens 20 while overlapping or aligning its fourth, fifth, and sixth regions 31, 32, 34 with the first, second, and third regions 21, 22, 23 of the first lens 20, respectively, and disposing at least a substantial portion or area of the inactive region beyond an left edge of the first lens 20. As described above, magnifications of the regions 21-23, 31, 32, 34 may preferably be arranged to satisfy the relations of (3a) through (3f) so that at least a substantial area of overlapped portions of the first lens 20 may define an uniform magnification such as, M_{E1}, thereacross. The remaining inactive region 33 of the second lens 30 which does not overlap or align with the first lens 20 due to its greater size, and may or may not be able to define the identical magnification, M_{E1}, as the rest of the second lens 30 depending upon a magnification thereof.

In another position as shown in the right panel of FIG. 3G, the second lens 30 may be arranged to translate linearly and horizontally with respect to the first lens 20 by approximately a length or width of one of the regions 21-23 of the first lens 20 to the right. Therefore, at least a substantial portion (or area) of the fourth region 31 of the second lens 30 may be positioned beyond a right edge of the first lens 20, whereas at least a substantial portion or area of the fifth region 32 of the second lens 30 may overlap or align with the first region of the first lens 20. At least substantial portions (or areas) of the sixth and inactive regions 34, 33 of the second lens may respectively overlap or align with the second and third regions 22 of the first lens 20. As described above, magnifications of the regions 21-23, 32-34 may preferably be arranged to satisfy the relations of (3a) to (3f) so that at least a substantial area of overlapped portions of the first lens 20 may be able to define an uniform magnification such as, M_{E2}, thereacross. Thus, at least a substantial portion (or area) of the first lens 20 may be able to define an uniform magnification such as, M_{E2}, thereacross as exemplified by the foregoing relations (3a) through (3f). The remaining third region 31 of the longer or wider second lens 30 which does not overlap (or align with) the first lens may or may not be able to have the same magnification, M_{E1}, as the rest of the second lens 30 depending upon its magnification.

Configurational and/or operational variations and/or modifications of the above aspects and/or embodiments of such exemplary lenses and various assemblies including such lenses as described in FIGS. 1A through 3G also fall within the scope of the present invention.

As described in the foregoing, one of the main features of the present invention is that at least two lenses are operatively coupled to each other to form a lens assembly and that one of such lenses are arranged to move with respect to the other. More particularly, such lenses are generally arranged to include multiple regions having different magnifications in such a way that different regions of such lenses overlap (or align) with each other in order to define different effective magnifications in at least a substantial portion of overlapping areas of such lenses. Therefore, the lenses of this invention may include various regions defining various shapes and/or sizes. In this context, detailed shapes and/or sizes of such lenses and their regions are generally important to the scope of the present invention. However, such shapes and/or sizes of the lenses and their regions as well as movement direction of such lenses may not be critical to the scope of the present invention as far as the lens assembly may define different effective magnifications in at least a substantial portion of overlapping areas of such lenses, although such shapes and/or sizes of the lenses and their regions may determine an extent of the overlapping areas across which an effective uniform magnification may be accomplished in each position of the mobile lens.

The second main feature of the present invention is a method of determining magnifications of individual regions of multiple lenses of the lens assembly in such a way that such lenses may be able to define different magnifications in at least a substantial portion of an area overlapped by the lenses. As exemplified in FIGS. 2A and 3A, such a method may include the steps of assigning a magnification to each region of such lenses, deciding an effective magnification in each area of one of such lenses which are overlapped by different regions of such lenses in one position of the mobile lens, and then deciding another effective magnification in each area of one of such lenses which are overlapped by different regions of such lenses in another position of the mobile lens. It is to be understood that such a method may or may not yield an unique set of magnifications for each region of the lens assembly. For example, a set of equations generated by such a method may be overdetermined and fail to yield such a set of magnifications, i.e., at least one region of the lens may be assigned with two different magnifications. In this case, such a region may be assigned with one of such magnifications, where such a region may be able to define a desired effective magnification in one position of the mobile lens but fail to define another desired effective magnification in another position of the mobile lens. When desirable, such a region may be replaced by the inactive regions which has been described above.

It is appreciated that details of the above method may be determined by various factors such as, e.g., orientation and/or disposition of various regions of the lenses, allocation of the stationary and mobile lenses, movement direction of the mobile lens, extent of movement of the mobile lens, shapes and/or sizes of the regions of the stationary and mobile lenses, and so on. Accordingly, the equations exemplified in conjunction with FIGS. 2A and 3A may have to be modified when the lenses of FIGS. 2A and 3A may include various regions numbered in different ways, may move along different directions, may move by a different distance and/or angle, and so on.

Multiple lenses of the lens assemblies of this invention may be disposed at various distances. For example, the first and second lenses may be disposed at a preset distance such as, e.g., 10 mm, 7 mm, 5 mm, 3 mm, 1 mm or less. In the alternative, such lenses may be disposed in close proximity as long as the mobile lens has a room to move between its multiple positions without being obstructed by the stationary lens. In another alternative, opposing surfaces of such lenses may be contoured such that one lens may move with respect to the other while maintaining close proximity therebetween. As far as such lenses may be able to define different effective magnifications in different positions of the mobile lens, exact disposition of one lens with respect to the other may be material to the scope of the present invention. In addition, the mobile lens may be disposed closer to the eye of the user or, in the alternative, the stationary lens may be disposed closer to the eye of the user.

It is to be understood that various embodiments of the above lenses and their regions may be applied interchangeably. For example, various lenses which have been exemplified to translate may be arranged to rotate or pivot, while other lenses which have been exemplified to rotate may instead be arranged to translate horizontally, vertically, and/or at an angle which may not be 90 degrees or 0 degree.

The foregoing lenses may be arranged to define various regions capable of defining more than two effective magnifications across at least substantial portions of overlapped areas of such lenses. In such an embodiment, at least one mobile lens may instead be arranged to move between more than two positions, where the lens assembly may define different effective magnifications in each of such positions. Regardless of the number of such effective magnifications, the lens assembly may also be arranged to include more than two lenses, in which at least two of such lenses may be stationary or mobile.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A multifocal lens assembly comprising:
a first lens;
a second lens movably disposed with respect to said first lens; and
at least one coupling member configured to allow movement of said second lens with respect to said first lens between at least two preset positions,
wherein said second lens is configured to move and overlap a different part of said first lens in each of said positions and to define a different magnification across at least a substantial portion of said overlapped part in at least two of said positions.

2. The lens assembly of claim 1, wherein said first lens is configured to have a first front surface and a first rear surface and to include a first plurality of regions each configured to be bound by both of said first surfaces, wherein said second lens is configured to define a second front surface and a second rear surface and to include a second plurality of regions each configured to be bound by both of said second surfaces, wherein said first lens is oriented so that its at least two of said regions are configured to define magnifications which increase successively along a preset curvilinear direction, wherein said second lens is oriented so that its at least two of said regions are configured to define magnifications which decrease successively along said preset curvilinear direction, and wherein said first and second lenses are configured to define different magnifications across at least substantial portions of overlapping parts of said lenses in at least two of said preset positions.

3. The lens assembly of claim 1, wherein one of said first and second lenses is configured to be one of a concave lens and a convex lens.

4. The lens assembly of claim 1, wherein at least one of said lens is configured to have a shape which is one of a triangle, a square, a trapezoid, a polygon, a circle, and an oval.

5. The lens assembly of claim 1, wherein said second lens is configured to at least one of rotate about an edge of said first lens, rotate about an interior point of said first lens, to translate vertically, to translate horizontally, and to translate at a preset angle.

6. The lens assembly of claim 1, wherein said magnifications of said regions adjoining each other are configured to increase successively by a same preset ratio along said direction.

7. The lens assembly of claim 1, wherein said magnifications of said regions adjoining each other are configured to decrease successively by a same preset ratio along said direction.

8. The lens assembly of claim 1, wherein one surface of said first lens and a matching surface of said second lens are configured such that said second lens is movably disposed behind said first lens in a close proximity.

9. The lens assembly of claim 1, wherein said first lens is configured to include at least two first regions with different magnifications, wherein said second lens is configured to include at least two second regions with different magnifications, and wherein at least one of said second regions of said second lens is configured to move and overlap a different first region of said first lens in each of said positions and to have a different magnification over at least a substantial portion of said different first region of said first lens in at least two of said positions.

10. The lens assembly of claim 9, wherein at least two of said regions are configured to extend in at least one of an at least substantially similar length, width, height, and angle.

11. The lens assembly of claim 9, wherein at least two of said regions are configured to define at least one of different lengths, widths, heights, and angles.

12. The lens assembly of claim 9, wherein at least one of said first and second regions of one of said first and second lenses is configured to align with one of adjoining regions of another of said first and second lenses in one of said positions and to align with another of said adjoining regions of said another of said first and second lenses in the other of said positions

13. A pair of glasses for refracting light rays transmitting therethrough and correcting at least one of myopia, hyperopia, and astigmatism of an user comprising:
a frame including at least one leg and at least one nose support;
at least one lens assembly configured to be coupled to a portion of said frame, to be disposed in front of one eye of said user, and to include a first lens and a second lens; and
at least one coupling member configured to move, respectively, said second lens with respect to said first lens while maintaining overlapping of at least a portion of said second lens over at least a portion of said first lens between at least two positions,
wherein said second lens is configured to overlap different portions of said first lens in each of said positions, thereby defining different magnifications in each of said positions.

14. The pair of glasses of claim 13 having a left lens assembly and a right lens assembly, wherein said left lens assembly is configured to couple with a left portion of said frame, to be disposed in front of a left eye of said user, and to include a first left lens and a second left lens, wherein said right lens assembly is configured to be coupled to a right portion of said frame, to be disposed in front of a right eye of said user, and to have a first right lens and a second right lens, wherein said coupling member is configured to move said second left and right lenses relative to said first left and right lens between at least two positions, respectively, while maintaining overlapping of at least a portion of said second left lens over at least a portion of said first left lens as well as overlapping of at least a portion of said second right lens over at least a portion of said first right lens, and wherein each of said second left and right lenses is configured to respectively overlap different areas of said first left and right lenses and to define different magnifications in said positions.

15. The pair of glasses of claim 13, wherein at least two of said regions are configured to define different refraction indices.

16. The pair of glasses of claim 13, wherein said frame is configured to encircle an entire portion of at least one of said lenses.

17. The pair of glasses of claim 13, wherein said frame is configured to encircle only a portion of at least one of said lenses.

18. A method of varying magnifications of a lens assembly comprising the steps of:
disposing a first lens to a body of said assembly;
providing a plurality of first regions having different magnifications;
movably implementing a second lens;
providing a plurality of second regions having different magnifications; and
moving said second lens with respect to said first lens while overlapping at least one region of said second lens by at least two of said regions of said first lens, thereby varying magnifications in at least a portion of at least one overlapping region of said first and second lenses due to said moving.

19. The method of claim 18, wherein said moving is configured to include at least one of translating vertically, translating horizontally, rotating angularly about a point on an edge of said first lens, rotating about a point inside said first lens, and translating at a preset angle.

20. The method of claim 18 further comprising the step of making said second lens one of smaller than, the same as, and larger than said first lens.
